(19) United States
(12) Patent Application Publication
(10) Pub. No.: US 2025/0252032 A1
(43) Pub. Date: Aug. 7, 2025

(54) METHODS AND SYSTEMS FOR GENERATING, TRAINING, COMBINING, CASCADING, AND USING FEDERATED LANGUAGE MODELS IN AN ENTERPRISE CONTEXT

(71) Applicants: Soham Pranav Shah, Redwood City, CA (US); Souvik Sen, Sunnyvale, CA (US); Surojit Chatterjee, Los Altos, CA (US)

(72) Inventors: Soham Pranav Shah, Redwood City, CA (US); Souvik Sen, Sunnyvale, CA (US); Surojit Chatterjee, Los Altos, CA (US)

(73) Assignee: Ema Unlimited Inc., Mountain View, CA (US)

(21) Appl. No.: 19/174,844

(22) Filed: Apr. 9, 2025

Related U.S. Application Data
(63) Continuation-in-part of application No. 18/433,598, filed on Feb. 6, 2024.

(51) Int. Cl. G06F 11/34; G06F 16/3329

(52) U.S. Cl. CPC G06F 11/3428; G06F 16/33295

(57) ABSTRACT

Systems and methods for training and using large language models to respond to queries and cascading to new models when their performance falls below a threshold during the response generation cycle are described. The methods involve receiving and analyzing a query using heuristics to determine the query's categories and a level of granularity at which its response is to be evaluated. Selecting a language model based on the query analysis and during the generation of the response, evaluating the model's performance for its ability to predict the next segment in a response. The methods score the evaluation and use the score to determine whether the language model's performance exceeds a confidence threshold. If it does not, then during the response is being generated, e.g., at a point before the response generation is completed, cascading from the model to a different model that can perform at a higher confidence level.

### CROSS-REFERENCE TO RELATED APPLICATIONS

This application is a continuation-in-part (CIP) of U.S. patent application Ser. No. 18/433,598, filed Feb. 6, 2024, the disclosures of this application are incorporated herein by reference in their entirety.

### FIELD OF INVENTION

Embodiments of the present disclosure relate to identifying language models for use in responding to a query and automatically switching the identified language model to another language model, or determining to continue with the identified language model, in the midst of receiving the query and before its completion, based on the identified language model's performance confidence.

### BACKGROUND

ChatGPT™, Gemini™, Grok™, Perplexity™, Claude™, and Deepseek™ are some examples of popular AI generative engines that are currently used by users to get their queries answered. They have become widely used for several types of tasks such as receiving answers to queries, generating code, and even document preparation. These AI generative engines, such as those described above, use Large Language Models (LLMs) to generate a response to the query. These LLMs rely on a foundational architecture that predicts the next word in a sequence to construct a response on a word-by-word basis.

While this approach is useful, it is limited by the scope and quality of the training data set used for training the LLM. As such, LLMs frequently generate inaccurate or fabricated information, known as hallucinations, when faced with queries that do not fall within their training data, i.e., since the training data used to train the LLM may be insufficient, rather than admitting to not knowing the answer, the LLM may generate an incorrect response. Such incorrect responses may be prevalent when queries requiring factual accuracy and domain-specific knowledge are entered and the LLM has not been trained with corresponding data.

Another drawback with the current AI generative engines is that they rely on a single LLM to process and respond to user queries. As described earlier, if the LLM used has not been trained with relevant data, or has been trained with incomplete, inaccurate, or incorrect data, then the LLM may hallucinate and produce responses that have incorrect information. Such errors, hallucinations, or inaccuracies are either not detected at all or detected only after the entire response has been generated. This late-stage error detection leads to inefficient resource utilization, as complex queries that necessitate substantial computational resources may ultimately yield unsatisfactory or incorrect results and that too at the expense of utilizing valuable computational resources to generate the response.

Since there are currently no effective methods of detecting such errors, hallucinations, or inaccuracies, users are forced manually to perform their own verifications to ensure that the response provided by using the LLM is accurate. As such, users that detect an error may manually perform additional queries or search outside the AI interface, such as on the Internet, to perform the verification. Having to perform verifications manually undermines the intended efficiency and reliability of the AI systems, as it places the burden of error detection and correction on the user.

In many instances, if the user is not skilled or savvy, they may take the response as is and not recognize that it contains errors and inaccuracies thereby potentially causing damage to their own reputation and also of their company depending on how they use such inaccurate responses.

As such, there is a need for an efficient and robust method and system that increases the confidence of using LLMs, performs early verifications, and takes remedial measures when an LLM response does not meet a confidence threshold.

### BRIEF DESCRIPTION OF THE DRAWINGS

FIG. 1 is a flowchart of an example of a process for generating and training federated large language models (LLMs) and using them by applying combining and cascading techniques in an enterprise context, in accordance with some embodiments of the disclosure;

FIG. 2 is a block diagram of an example of a system for generating and training federated large language models and using them by applying combining and cascading techniques in an enterprise context in accordance with some embodiments of the disclosure;

FIG. 3 is a block diagram of an example of an electronic device used for performing the functions described herein, in accordance with some embodiments of the disclosure;

FIG. 4 is flowchart of an example of a process for obtaining enterprise data and generating and training enterprise LLMs (ELLMs), in accordance with some embodiments of the disclosure;

FIG. 5 is a block diagram of an example of using enterprise data to generate MELLMs, in accordance with some embodiments of the disclosure;

FIG. 6 is a block diagram of an example for determining data classification and curating data quality for its use to train the ELLMs, in accordance with some embodiments of the disclosure;

FIG. 7 is flowchart of an example of a multi-layer process for selecting a plurality of language models, applying combining and cascading techniques, and obtaining a curated/enhanced response, in accordance with some embodiments of the disclosure;

FIG. 8 is a block diagram of an example of a response and predictive response options provided at different locations in the response by the language models used, in accordance with some embodiments of the disclosure;

FIG. 9 is a block diagram for selecting a final language model by applying cascading and verification techniques to switch between models or stay with the same model based on confidence determinations, in accordance with some embodiments;

FIG. 10 is a block diagram for exemplary categories that may be associated with query, in accordance with some embodiments of the disclosure;

FIG. 11 is a table depicting selection of an initial language model based on categorization of the category of the query received, in accordance with some embodiments of the disclosure;

FIG. 12 is a diagram depicting selection of a language model based on categorization of the query received, in accordance with some embodiments of the disclosure;

FIG. 13 is a block diagram of determining confidence scores at particular locations of the response and making cascading decisions based on the confidence scores, in accordance with some embodiments of the disclosure;

FIG. 14 is a block diagram of representing taxonomy of the query and various evaluation techniques used for each type of taxonomy, in accordance with some embodiments of the disclosure;

FIG. 15 is flowchart of an example of types of verifications performed, in accordance with some embodiments of the disclosure;

FIG. 16 is a block diagram of an example of selection of enterprise and public language models and their use to obtain a curated/enhanced response or portion of the response, in accordance with some embodiments;

FIG. 17A is an example of a simple query that may be entered for obtaining a curated/enhanced response, in accordance with some embodiments of the disclosure;

FIG. 17B is an example of a multi-part query or a more descriptive question that may be entered for obtaining a curated/enhanced response/answer, in accordance with some embodiments of the disclosure;

FIG. 18 is a block diagram of an example of matching a language model to a query based on the categorization of the query, context of the query, and/or the user credentials, in accordance with some embodiments of the disclosure;

FIG. 19 is a block diagram of an example of selection criteria used for selecting an initial or cascaded language model, in accordance with some embodiments of the disclosure;

FIG. 20 is a block diagram of an example of different tiers of access levels associated with different tiers of employees based on their job titles, in accordance with some embodiments of the disclosure;

FIG. 21 is a block diagram of an example of selecting ELLMs from different departments in a company based on their contextual and categorical relationship to the input query, in accordance with some embodiments of the disclosure;

FIG. 22 is a block diagram of an example of a nested ELLM, in accordance with some embodiments of the disclosure;

FIG. 23 is a block diagram of an example of using public LLMs to respond to the query, in accordance with some embodiments of the disclosure;

FIG. 24 is a block diagram of an example of using ELLMs to respond to a query, in accordance with some embodiments of the disclosure;

FIG. 25 is a block diagram of an example of using both public LLMs and ELLMs to respond to a query, in accordance with some embodiments of the disclosure;

FIGS. 26A and 26B are exemplary tables is that depict cost and accuracy provided by each LLM (or ELLM) that may be used in narrowing the selection of LLMs and ELLMs to process a query, in accordance with some embodiments of the disclosure;

FIG. 26C is an exemplary table that may be used to determine accuracy parameters based on the importance level of the query and/or response, in accordance with some embodiments of the disclosure;

FIG. 27 is an example of a chart that depicts economic efficiency between language models, which may be used as a metric in selecting a language model, in accordance with some embodiments of the disclosure; and

FIG. 28 is an exemplary graph that depicts a balance between routing accuracy and performance used as a metric in selecting a language model, in accordance with some embodiments of the disclosure.

### DETAILED DESCRIPTION

In accordance with some embodiments disclosed herein, the above-mentioned limitations are overcome by training language models using various data classification and quality enhancement techniques, receiving and categorizing a query based on an analysis, selecting an initial model based on the categorization to generate a response to the query, testing the confidence of response in the midst of generating the response and prior to the response being completed, determining confidence scores relating to the portion of the response generated by the initial language model, selecting a distinct second language model if the confidence level of the portion of the response generated by the initial model is below the confidence threshold or continuing with the initial model if the confidence level of the portion of the response generated by the initial model is above the confidence threshold, continuing to test confidence at various points or location in the response while the response is being generated such that course or error correction can be performed in the midst of the generation of the response rather than waiting to evaluate the response once it is completed.

The above-mentioned limitations are overcome by using various factors for selecting language models for responding to query, performing early course correction, error detection, and verification in the midst of generating the response and continuing the evaluation through as segments of the response are generated in real-time to cascading between language models, performing cascading to increase output confidence, and using various language models, combination of language models, and ensemble model to generate a final response to the query.

The above-mentioned limitations are also overcome by associating the training data with one or more enterprise functions and departments. The above-mentioned limitations are also overcome by associating the training data with different levels of access, including different levels of authorization for different employees of an enterprise, such as based on the confidential and proprietary nature of the training data. The association with one or more enterprise functions and departments and the level of access/authorization, among other factors, is taken into consideration to generate contextually distinguished ELLMs. For example, ELLMs that have been trained on finance data may be generated separately from another ELLM that has been trained with engineering data. Likewise, an ELLM that has been trained with a higher tier of confidential data may be generated separately from an ELLM that has been trained with data with a lower tier of confidentiality and is available to all employees of the enterprise. The above-mentioned limitations are also overcome by selectively combining one or more generated ELLMs, as well as any publicly available LLMs, where the combinations of ELLMs and LLMs are selected based on both the identity of the user as well as the context of the question. The selected combination of ELLMs and LLMs are used to process a question inputted by a user. Answers obtained by processing the question via the combination of ELLMs and LLMs are blended and used as an input into an ensemble model to obtain a final answer. The above-mentioned limitations are also overcome by using a cascading approach that switches between a plurality of language models to perform early course correction and increase confidence during the receiving of the query. In other words, as the query is being received, and the complete query has not been received yet, during the progression of receiving the query on a character by character, word by word, or chunk by chunk basis as the query is being inputted and received, the systems perform an evaluation of the model's predictive abilities, and switch models when the confidence level of the prediction is below a threshold.

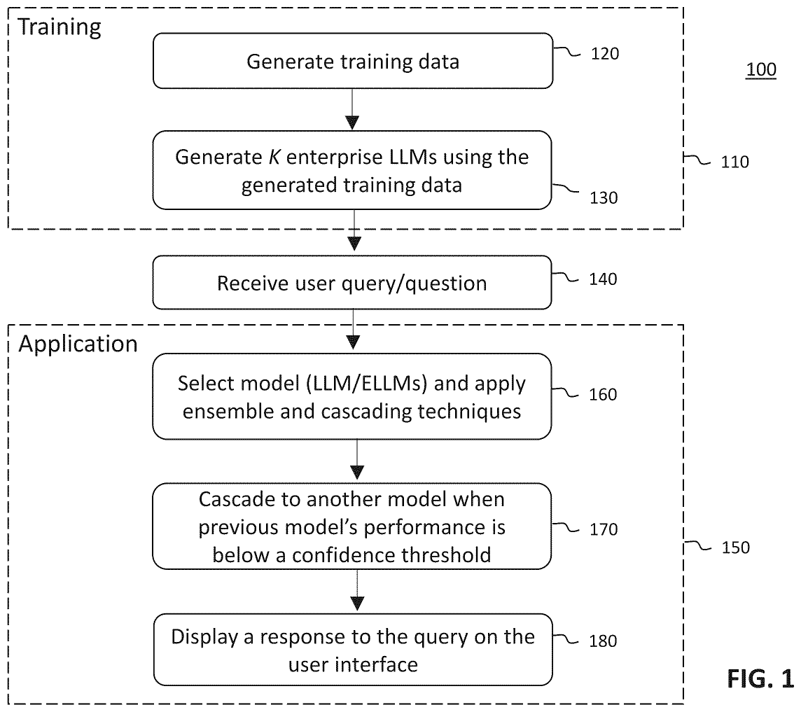

Turning to the figures, FIG. 1 is a flowchart 100 of an example of a process for generating and training enterprise related federated large language models (ELLMs) and combining and using them in an enterprise context, in accordance with some embodiments of the disclosure. In some embodiments, these generated ELLMs, along with LLMs, may be used at the initial stage of selecting a model for responding to a query or may be selected anytime through the response generation process when cascading/switching is performed to switch to another model due to an earlier model performing below a threshold confidence level.

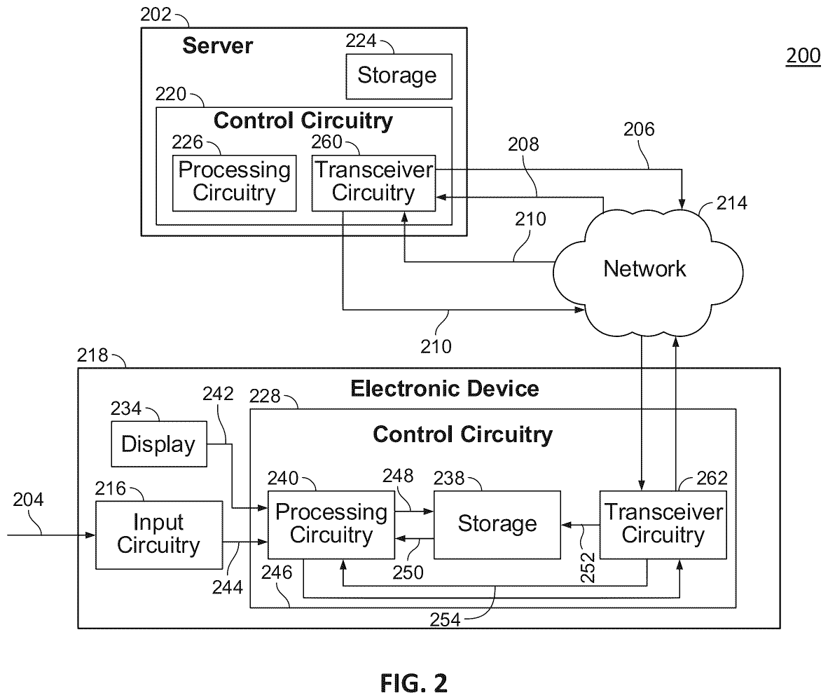

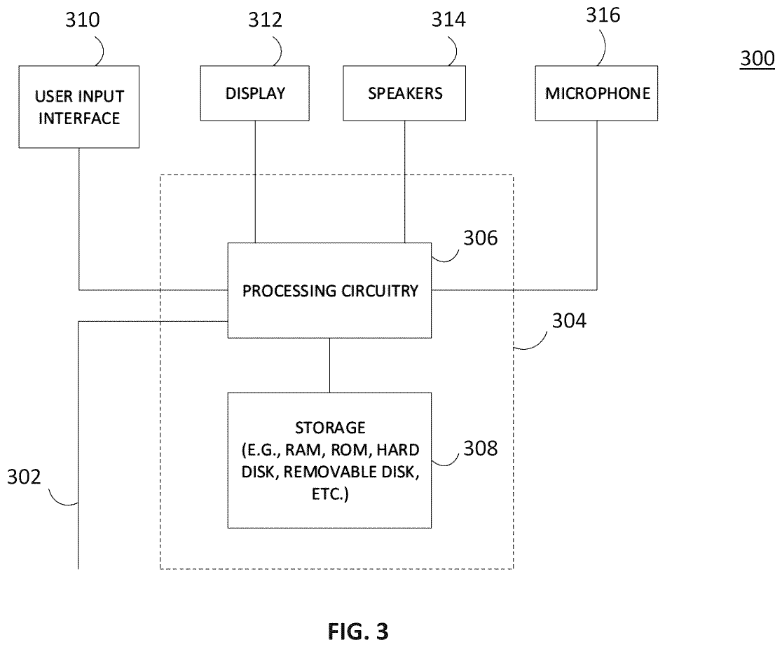

Process 100 may be implemented, as a whole or in part, by systems or devices such as those shown in FIGS. 2-3. One or more actions of process 100 may be incorporated into or combined with one or more actions of any other process or embodiments described herein. Process 100 may be saved to a memory or storage (e.g., any one of those depicted in FIGS. 2-3) as one or more instructions or routines that may be executed by a corresponding device or system to implement the method. In some embodiments, reference 110 may relate to training of a model and 150 to applying the trained model.

In some embodiments, at block 120, training data may be generated. The training data may be used for generating and training enterprise based large language models, herein referred to as ELLM(s), enterprise LLM(s), private LLM(s) or federated large language models. Generating training data to generate an ELLM, in some embodiments, involves accessing various databases, executable applications, document libraries, various servers, such as email servers, department servers, and any storage devices and applications used by the enterprise for storing data.

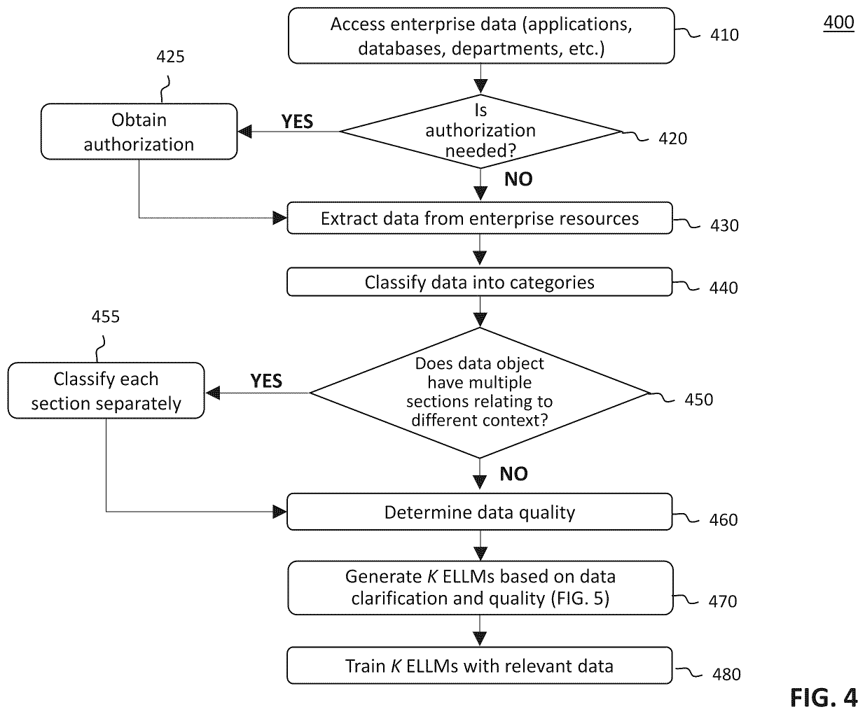

Training the ELLM using enterprise data and using it to respond to enterprise related queries provides several advantages. For example, an ELLM is private, i.e., the data used to train the ELLM is not publicly shared, and its data privacy and security is protected. In another example, it is easier to update an ELLM. Since the training data is managed within the enterprise, system administrators or managers associated with the data within the enterprise may be able to have a higher level of control over updates, improvements, deletions, and changes in use of enterprise data and be able to change it easily and quickly as needed. For example, a trained ELLM may be updated internally at an enterprise by using updated data from a department to replace older data and obtain a curated response to a related query. Since responses to some of the queries provided to an ELLM may affect the outcomes of decisions made in a company, including decisions relating to key company business and strategy, ensuring that the training data used in the ELLMs is classified, updated, and quality checked accurately becomes very critical. Furthermore, having a properly classified and quality checked ELLM also allows the enterprise to have the most control of the ELLM's performance and ensure that proper, updated, and accurate data is being used. FIGS. 4-6 describe in further detail some embodiments of how such enterprise data is accessed, classified, curated for quality, and made available for it to be used as training data for ELLMs.

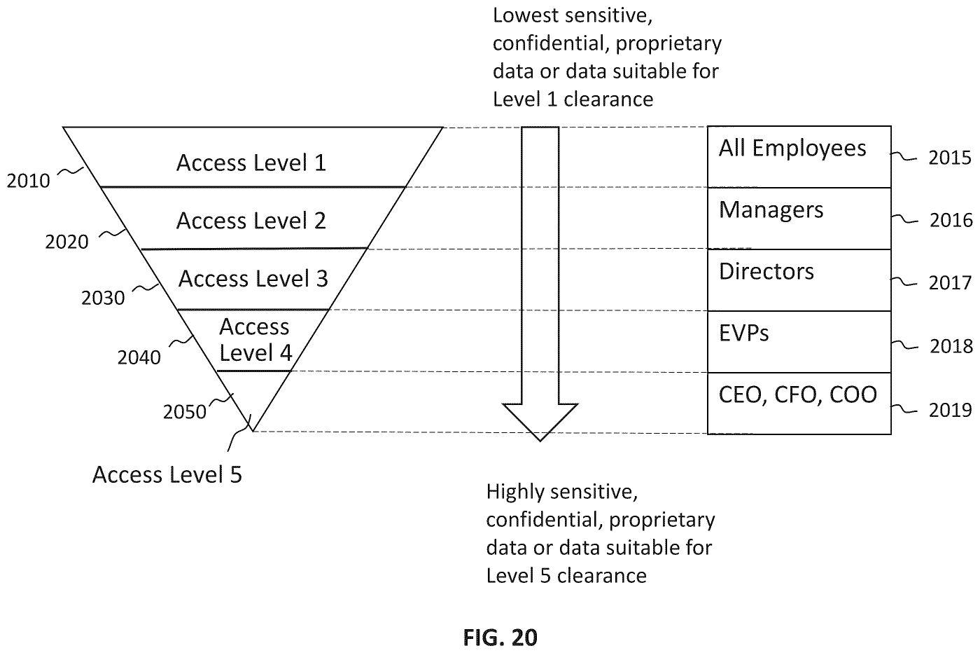

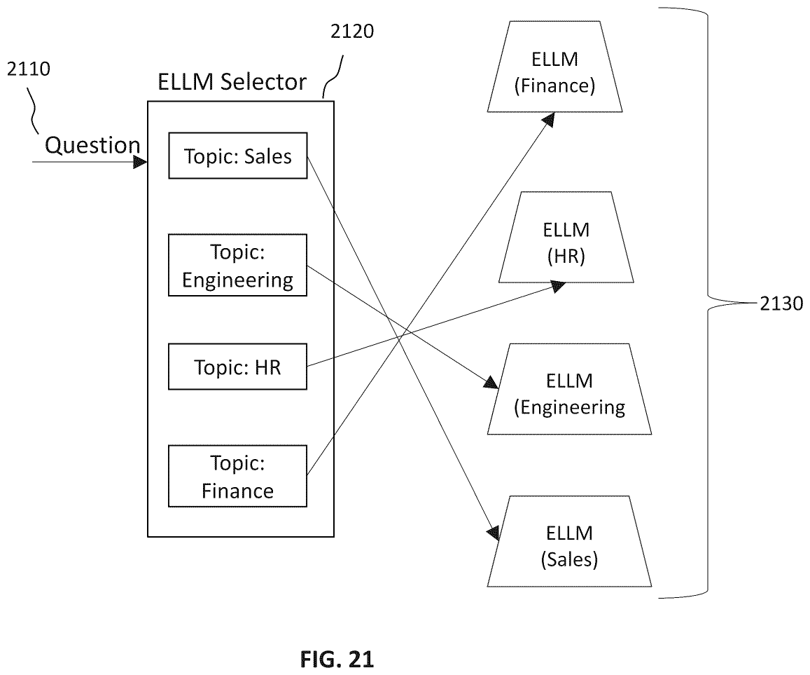

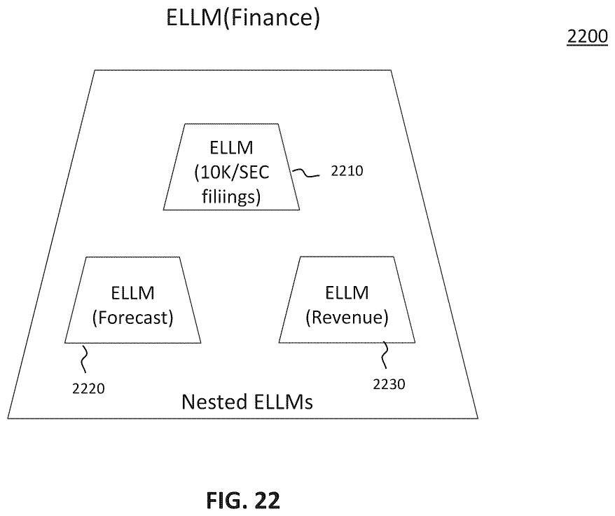

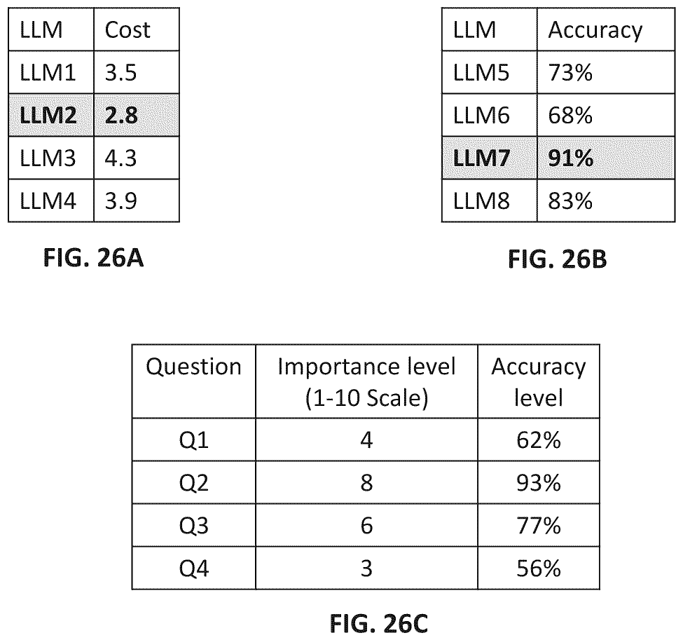

At block 130, in some embodiments, the control circuitry, such as the control circuitry 228 and/or 220 of system 200 in FIG. 2, may generate K number of ELLMs using the training data generated. In doing so, the control circuitry 228 and/or 220 may use classified data that is curated for its quality to generate a plurality of ELLMs. Such ELLMs may be ELLMs that provide different tiers of access to content where such access is authorized based on the job level or title of an employee, as depicted in FIG. 20, ELLMs that are department specific, as depicted in FIG. 21, nested ELLMs that are further sub-categorized under a main category, as depicted in FIG. 22, ELLMs that are generated based on cost or accuracy basis as depicted in FIGS. 26A-C and 27-28, ELLMs that are application specific, and other types of ELLMs that are discussed in the embodiments herein.

At block 140, the control circuitry 228 and/or 220 may receive a query from a user that seeks a response. In some instances, the query may be a simple query (e.g., such as query depicted in 17A) with a single ask and in other embodiments the query may be a multipart or complex query (e.g., such as query depicted in 17B) that may require multiple responses or responses that are based on multiple factors. In some embodiments, the query may simply seek a response and in other embodiments the query may seek a response as well as the reasoning and steps taken to get to the response.

At block 140, upon receiving the query, the control circuitry 228 and/or 220 may analyze the query to determine categories associated with the query, and at block 160 may strategically select a single or a combination of ELLMs and/or public LLMs based on the determined category, use the strategically selected combination of ELLMs and/or public LLMs to respond to the query, blend the responses based on various criterion, and then perform an ensemble technique to obtain a curated response to the query, and cascade to another ELLMs and/or public LLMs when the previous ELLMs and/or public LLM's response falls below a confidence threshold. When referring to a confidence threshold, it is the minimum confidence score that needs to be exceeded for a determination to be made that the model is operating, in its predictive ability, to at least a confidence that is acceptable. For example, a confidence threshold may be set at 70%, or medium, or 7/10 on a confidence scale. These scores may represent the minimum confidence thresholds a model must satisfy to be deemed operating with an acceptable level of confidence for determination. As such, a model that is operating at 60%, low, or 6/10 (using the exemplary scale above) may be said to be operating below the confidence threshold, or said in another way, is not exceeding the confidence threshold. On the other hand, a model that is operating at 71%, high, or 8/10 (using the exemplary scale above) may be said to be operating above the confidence threshold, or said in another way, exceeding the confidence threshold.

At block 170, the control circuitry 228 and/or 220, while the response is being generated, evaluate the performance of the ELLMs and/or public LLMs used for generating the response and if their performance, as it relates to predicting the nest segment (e.g., word, chunk of words, portions or entire response) falls below a threshold, then the control circuitry may switch from a current ELLMs and/or public LLMs to another distinct ELLMs and/or public LLMs to perform course correction. The newly selected ELLMs and/or public LLMs may also be evaluated for its performance. As such, the control circuitry may continue to perform evaluations throughout the course of the response generation cycle, at various point during the generation based on a level of granularity determined, and either continue with same model that generated the previous segment or switch/cascade to a new ELLMs and/or public LLMs depending on their performance exceeding the confidence threshold. Additional details of the process are described in the description related to FIGS. 4-28.

At block 150, the curated response, also referred to herein as the golden response, may then be displayed to the user from whom the query was received on their electronic device. The response to a user's query may be displayed on the same user interface used for input or delivered to other devices as specified by the user. This includes text messages to mobile phones, distribution to multiple employees, or segmented delivery to different individuals or departments based on relevance. Users may also establish rules for response delivery, including recipients, timing, and formatting. The curated response may be the entire response or portions of the response at a time. For example, a first portion may be displayed and if any model cascading needs to be done to select a second model and then using the second model produce the next portion, it may be performed and then using the second model, the next portion of the response may be displayed to the user. The process of cascading displaying different portions may be performed in the back end and at a very high pace such that the end user that input the query may not be visually able to see any delays between displaying of different portions.

FIG. 2 is a block diagram of an example of a system for generating and training federated large language models and using them by applying combining and cascading techniques in an enterprise context in accordance with some embodiments of the disclosure and FIG. 3 is a block diagram of an example of an electronic device used for performing the functions described herein, in accordance with some embodiments of the disclosure.

FIGS. 2 and 3 also describe exemplary devices, systems, servers, and related hardware that may be used to implement processes, functions, elements and components, and functionalities described in relation to FIGS. 1 and 4-28. Further, FIGS. 2 and 3 may also be used to obtain enterprise data from a plurality of enterprise resources, classify and curate the obtained data, such as based on data quality and data type, generate training data from the classified and curated data, and use the training data to generate a plurality of contextually distinguished ELLMs. FIGS. 2 and 3 may also be used to associate the training data with one or more enterprise functions and department, associate the training data with different level of access, including different levels of authorization for different employees of an enterprise, such as based on the confidential and proprietary nature of the training data, consider and evaluate one or more enterprise functions and departments and the level of access/authorization based on such consideration and evaluation to generate contextually distinguished ELLMs, including separately generating ELLMs different ELLMs that have been trained with a higher tier of confidential data from an ELLM that have been trained with data with a lower tier of confidentiality. FIGS. 2 and 3 may also be used to selectively combine one or more generated ELLMs, as well as any publicly available LLMs, where the combinations of ELLMs and LLMs are selected based on both the identity of the user as well as the context of the question and using the selected combination of ELLMs and LLMs to process a question inputted by a user. FIGS. 2 and 3 may also be used to obtain one or more answers by processing the question via the combination of ELLMs and LLMs and blending the answers to then use them as input in an ensemble model to obtain a final answer. FIGS. 2 and 3 may also be used for automatically determining various combinations or ELLMs and LLMs to use, to determine a sequence of their use, revise the sequence based on answers received from user LLMs and ELLMs, and generate one or more answers to queries that take into account the identity of the user as well as the content and context of the question. FIGS. 2 and 3 may also be used to analyze a query, categorize the query based on the analysis, select a model to respond to the query, determine a granularity based on the category for evaluating performance of a language model with respect to its prediction capabilities and predictions made for generating a portion of the response, such as the next segment, switching or cascading to another model if the previous model's performance is determined to be below a confidence threshold, using token-based, chunk-based, or response-level based granularity and one or more of various evaluation methods including logit-based, self-reporting based, rewards-based, and judge-based evaluations of the model's performance, and continuing evaluation at various stages of a response, before the full response is completed, such that any course or error correction can be performed earlier and during the various stages of the response being generated, and not yet completed, and performing some evaluation steps after the response-level.

In some embodiments, one or more parts of, or the entirety of system 200, may be configured as a system implementing various features, processes, functionalities and components of FIGS. 1 and 4-28. Although FIG. 2 shows a certain number of components, in various examples, system 200 may include fewer than the illustrated number of components and/or multiples of one or more of the illustrated number of components.

System 200 comprises computing device 218, server 202, and communication network 214. While FIG. 2 depicts single instances, multiple components can be employed. Server 202, for example, might consist of several servers, and communication network 214, multiple networks. Server 202 connects to computing device 218 via communication network 214, though a direct connection is possible, bypassing network 214. Communication network 214 can include various networks, like the internet, LAN, or WIFI. In some setups, system 200 omits server 202, with its functions performed by other components, such as within communication network 214. Conversely, server 202 can cooperate with communication network 214 for distributed functionality. Similarly, computing device 218 might be excluded, with its functions handled by communication network 214 or server 202, or a combination. Computing device 218 can also work with communication network 214 or server 202 in a distributed manner.

Computing device 218 includes control circuitry 228, display 234 and input circuitry 216. Control circuitry 228 in turn includes transceiver circuitry 262, storage 238 and processing circuitry 240. In some embodiments, computing device 218 or control circuitry 228 may be configured as media device 300 of FIG. 3.

Server 202 includes control circuitry 220 and storage 224. Each of storages 224 and 238 may be an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 4D disc recorders, solid state devices, quantum storage devices, gaming consoles, gaming media, or any other suitable fixed or removable storage devices, and/or any combination of the same. Each storage 224, 238 may be used to store various types of content, metadata, and or other types of data (e.g., they can be used to store ELLMs, user credentials, user profile and information, user association with different functions and departments within an enterprise, employee job titles and designations, contextual and content identifiers related to ELLMs to identify the type of content within each ELLM, input question, ensemble model, ELLM selection modules, cost and accuracy data associated with each ELLM and LLM, answers obtained via use of any combination of ELLMs and LLMs, golden answer, and machine learning data, and NLP, ML, and AI algorithms). Non-volatile memory may also be used (e.g., to launch a boot-up routine and other instructions). Cloud-based storage may be used to supplement storages 224, 238 or instead of storages 224, 238. In some embodiments, data relating to obtaining enterprise data from a plurality of enterprise resources, classifying and curating the obtained data, such as based on data quality and data type, generating training data from the classified and curated data, using the training data to generate a plurality of contextually distinguished ELLMs, associating the training data with one or more enterprise functions and department, associating the training data with different level of access, including different levels of authorization for different employees of an enterprise, such as based on the confidential and proprietary nature of the training data, considering and evaluating one or more enterprise functions and departments and the level of access/authorization based on such consideration and evaluation to generate contextually distinguished ELLMs, including separately generating ELLMs different ELLMs that have been trained with a higher tier of confidential data from an ELLM that have been trained with data with a lower tier of confidentiality, selectively combining one or more generated ELLMs, as well as any publicly available LLMs, where the combinations of ELLMs and LLMs are selected based on both the identity of the user as well as the context of the question and using the selected combination of ELLMs and LLMs to process a question inputted by a user, obtaining one or more answer by processing the question via the combination of ELLMs and LLMs and blending the answers to then use them as input in an ensemble model to obtain a final answer, and data relating to all other processes and features described herein, may be recorded and stored in one or more of storages 212, 238. Data also relating to analyzing a query, categorizing the query based on the analysis, selecting a model to respond to the query, determining a granularity based on the category for evaluating performance of a language model with respect to its prediction capabilities and predictions made for generating a portion of the response, such as the next segment, switching or cascading to another model if the previous model's performance is determined to be below a confidence threshold, using token-based, chunk-based, or response-level based granularity and one or more of various evaluation methods including logit-based, self-reporting based, rewards-based, and judge-based evaluations of the model's performance, and continuing evaluation at various stages of a response, before the full response is completed, such that any course or error correction can be performed earlier and during the various stages of the response being generated, and not yet completed, and performing some evaluation steps after the response-level may be recorded and stored in one or more of storages 212, 238.

In some embodiments, the control circuitry 220 and/or 228 may execute application instructions stored in memory, such as storage 224 and/or 238, to perform the functions described. In some implementations, all actions of control circuitry 220 and/or 228 are based on these application instructions. The application, stored in storage 224 and/or 238, is executed by control circuitry 220 and/or 228. In certain embodiments, the application is a client/server setup, with the client component on computing device 218 and the server component on server 202.

The application may be implemented using any suitable architecture. For instance, it might be a standalone application operating solely on computing device 218. In this setup, application instructions reside locally within storage 238, and data updates are periodically downloaded from external sources, such as internet resources or out-of-band feeds, bypassing direct interaction with server 202. Control circuitry 228 may retrieve instructions for the application from storage 238 and process the instructions to perform the functionality described herein. Based on the processed instructions, control circuitry 228 may determine a type of action to perform in response to input received from input circuitry 216 or from communication network 214. For example, in response to determining that the user who has inputted the query in the prompt is an employee, the question relates to enterprise finance, and that the employee has authorization to receive confidential data that is below a level 6 (on a 1-10 scale where 10 may be the most confidential date), then automatically determining a strategy to use a combination of ELLMs that are finance related and include confidential data below the level 6. To accomplish this, in one embodiment, the control circuitry 228 may perform the steps of process described at least in any one or more of FIGS. 1, 4, 6-7, 9, 15-16, and 18 below and all the steps and processes described in all the figures depicted herein.

In client/server-based embodiments, control circuitry 228 may include communication circuitry suitable for communicating with an application server (e.g., server 202) or other networks or servers. The instructions for carrying out the functionality described herein may be stored on the application server. Communication circuitry may include a cable modem, an Ethernet card, or a wireless modem for communication with other equipment, or any other suitable communication circuitry. Such communication may involve the internet or any other suitable communication networks or paths (e.g., communication network 214). In another example of a client/server-based application, control circuitry 228 runs a web browser that interprets web pages provided by a remote server (e.g., server 202). For example, the remote server may store the instructions for the application in a storage device. The remote server may process the stored instructions using circuitry (e.g., control circuitry 228) and/or generate displays. Computing device 218 may receive the displays generated by the remote server and may display the content of the displays locally via display 234. This way, the processing of the instructions is performed remotely (e.g., by server 202) while the resulting displays, such as the display windows described elsewhere herein, are provided locally on computing device 218. Computing device 218 may receive inputs from the user via input circuitry 216 and transmit those inputs to the remote server for processing and generating the corresponding displays. Alternatively, computing device 218 may receive inputs from the user via input circuitry 216 and process and display the received inputs locally, by control circuitry 228 and display 234, respectively.

Server 202 and computing device 218 may transmit and receive content and data such as user data and user credentials, user profile, data related to user association with different functions and departments within an enterprise, data related to employee job titles and designations, training data for ELLMs, cost and accuracy data associated with each ELLM and LLM, and input from electronic devices, such as input queries and prompts. Control circuitry 220, 228 may send and receive commands, requests, and other suitable data through communication network 214 using transceiver circuitry 260, 262, respectively. Control circuitry 220, 228 may communicate directly with each other using transceiver circuits 260, 262, respectively, avoiding communication network 214.

Computing device 218, as described, may be versatile and not restricted to the specific configurations detailed. It may be in various forms, including personal computers, laptops, tablets, smartphones, and other devices capable of processing user queries and using various combinations of LLM and ELLM models, and generating a response.

Control circuitry 220 and/or 218 may use processing circuitry, such as processing circuitry 226 and/or 240, respectively. Processing circuitry encompasses circuitry based on microprocessors, microcontrollers, digital signal processors, programmable logic devices, FPGAs, ASICs, and may include multi-core processors. In some embodiments, the processing circuitry is distributed across multiple processors, which can be of the same type or different types. In some embodiments, control circuitry 220 and/or control circuitry 218 are configured to obtain enterprise data from a plurality of enterprise resources, classify and curate the obtained data, such as based on data quality and data type, generate training data from the classified and curated data, and use the training data to generate a plurality of contextually distinguished ELLMs. Control circuitry 220 and/or control circuitry 218 may also be configured to associate the training data with one or more enterprise functions and department, associate the training data with different level of access, including different levels of authorization for different employees of an enterprise, such as based on the confidential and proprietary nature of the training data, consider and evaluate one or more enterprise functions and departments and the level of access/authorization based on such consideration and evaluation to generate contextually distinguished ELLMs, including separately generating ELLMs different ELLMs that have been trained with a higher tier of confidential data from an ELLM that have been trained with data with a lower tier of confidentiality. Control circuitry 220 and/or control circuitry 218 may are also be configured to selectively combine one or more generated ELLMs, as well as any publicly available LLMs, where the combinations of ELLMs and LLMs are selected based on both the identity of the user as well as the context of the question and using the selected combination of ELLMs and LLMs to process a question inputted by a user. Control circuitry 220 and/or control circuitry 218 may also be configured to obtain one or more answers by processing the question via the combination of ELLMs and LLMs and blending the answers to then use them as input in an ensemble model to obtain a final answer. Control circuitry 220 and/or control circuitry 218 may are also be configured for automatically determining various combinations or ELLMs and LLMs to use, to determine a sequence of their use, revise the sequence based on answers received from user LLMs and ELLMs, and generate one or more answers to queries that take into account the identity of the user as well as the content and context of the question. Control circuitry 220 and/or control circuitry 218 may are also be configured to analyze a query, categorize the query based on the analysis, select a model to respond to the query, determine a granularity based on the category for evaluating performance of a language model with respect to its prediction capabilities and predictions made for generating a portion of the response, such as the next segment, switching or cascading to another model if the previous model's performance is determined to be below a confidence threshold, using token-based, chunk-based, or response-level based granularity and one or more of various evaluation methods including logit-based, self-reporting based, rewards-based, and judge-based evaluations of the model's performance, and continuing evaluation at various stages of a response, before the full response is completed, such that any course or error correction can be performed earlier and during the various stages of the response being generated, and not yet completed, and performing some evaluation steps after the response-level. Control circuitry 220 and/or control circuitry 218 are also configured to perform all processes described and shown at least in any one or more of FIGS. 1, 4, 6-7, 9, 15-16, and 18.

Computing device 218 receives a user input 204 at input circuitry 216. For example, computing device 218 may receive a user input like a question, query, or task to answer a math question, to perform algorithm testing to detect any bugs, determine financial projections for an enterprise, etc.

Transmission of user input 204 to computing device 218 may be accomplished using a wired connection, such as an audio cable, USB cable, ethernet cable or the like attached to a corresponding input port at a local device, or may be accomplished using a wireless connection, such as Bluetooth, WIFI, WiMAX, GSM, UTMS, CDMA, TDMA, 3G, 4G, 4G LTE, or any other suitable wireless transmission protocol. Input circuitry 216 may comprise a physical input port such as a 3.5 mm audio jack, RCA audio jack, USB port, ethernet port, or any other suitable connection for receiving audio over a wired connection or may comprise a wireless receiver configured to receive data via Bluetooth, WIFI, WiMAX, GSM, UTMS, CDMA, TDMA, 3G, 4G, 4G LTE, or other wireless transmission protocols.

Processing circuitry 240 may receive input 204 from input circuit 216. Processing circuitry 240 may convert or translate the received user input 204 that may be in the form of voice input into a microphone. In some embodiments, input circuit 216 performs the translation to digital signals. In some embodiments, processing circuitry 240 (or processing circuitry 226, as the case may be) carries out disclosed processes and methods. For example, processing circuitry 240 or processing circuitry 226 may perform processes as described at least in any one or more of FIGS. 1, 4, 6-7, 9, 15-16, and 18, respectively.

FIG. 3 is a block diagram of an example of an electronic device used for performing the functions described herein, in accordance with some embodiments of the disclosure. In an embodiment, the equipment device 300, is the same equipment device 202 of FIG. 2. The equipment device 300 may receive content and data via input/output (I/O) path 302. The I/O path 302 may provide audio content (e.g., broadcast programming, on-demand programming, internet content, content available over a local area network (LAN) or wide area network (WAN), and/or other content) and data to control circuitry 304, which includes processing circuitry 306 and a storage 308. The control circuitry 304 may be used to send and receive commands, requests, and other suitable data using the I/O path 302. The I/O path 302 may connect the control circuitry 304 (and specifically the processing circuitry 306) to one or more communications paths. I/O functions may be provided by one or more of these communications paths but are shown as a single path in FIG. 3 to avoid overcomplicating the drawing.

The control circuitry 304 may be based on any suitable processing circuitry such as the processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor).

The processes described herein may be implemented in or supported by any suitable software, hardware, or combination thereof. They may also be implemented on user equipment, on remote servers, or across both.

In client-server-based embodiments, the control circuitry 304 may include communications circuitry suitable for allowing communications between two separate user devices to obtain enterprise data from a plurality of enterprise resources, classify and curate the obtained data, such as based on data quality and data type, generate training data from the classified and curated data, and use the training data to generate a plurality of contextually distinguished ELLMs. Communications circuitry may are also be configured to associate the training data with one or more enterprise functions and department, associate the training data with different level of access, including different levels of authorization for different employees of an enterprise, such as based on the confidential and proprietary nature of the training data, consider and evaluate one or more enterprise functions and departments and the level of access/authorization based on such consideration and evaluation to generate contextually distinguished ELLMs, including separately generating ELLMs different ELLMs that have been trained with a higher tier of confidential data from an ELLM that have been trained with data with a lower tier of confidentiality. Communications circuitry may also be configured to selectively combine one or more generated ELLMs, as well as any publicly available LLMs, where the combinations of ELLMs and LLMs are selected based on both the identity of the user as well as the context of the question and using the selected combination of ELLMs and LLMs to process a question inputted by a user. Communications circuitry may also be configured to obtain one or more answers by processing the question via the combination of ELLMs and LLMs and blending the answers to then use them as input in an ensemble model to obtain a final answer. Communications circuitry may also be configured for automatically determining various combinations or ELLMs and LLMs to use, to determine a sequence of their use, revise the sequence based on answers received from user LLMs and ELLMs, and generate one or more responses to queries that consider the identity of the user as well as the content and context of the question. Communications circuitry may are also be configured to analyze a query, categorize the query based on the analysis, select a model to respond to the query, determine a granularity based on the category for evaluating performance of a language model with respect to its prediction capabilities and predictions made for generating a portion of the response, such as the next segment, switching or cascading to another model if the previous model's performance is determined to be below a confidence threshold, using token-based, chunk-based, or response-level based granularity and one or more of various evaluation methods including logit-based, self-reporting based, rewards-based, and judge-based evaluations of the model's performance, and continuing evaluation at various stages of a response, before the full response is completed, such that any course or error correction can be performed earlier and during the various stages of the response being generated, and not yet completed, and performing some evaluation steps after the response-level. Communications circuitry may are also be configured to perform all processes described and shown at least in any one or more of FIGS. 1, 4, 6-7, 9, 15-16, and 18.

Communications circuitry used for data exchange with other devices, may further include various modem types (cable, ISDN, DSL, telephone, wireless), ethernet cards, and other suitable components. These components may enable communication over the internet or other networks. Additionally, the circuitry supports peer-to-peer communication and communication between remote electronic equipment devices.

Memory may be an electronic storage device provided as the storage 308 that is part of the control circuitry 304. As referred to herein, the phrase “electronic storage device” or “storage device” should be understood to mean any device for storing electronic data, computer software, or firmware, such as random-access memory, read-only memory, hard drives, optical drives, BLU-RAY disc (BD) recorders, BLU-RAY 3D disc recorders, solid-state devices, quantum-storage devices, gaming consoles, gaming media, or any other suitable fixed or removable storage devices, and/or any combination of the same.

The storage 308 may be used to store ELLMs, user credentials, user profile and information, user association with different functions and departments within an enterprise, employee job titles and designations, contextual and content identifiers related to ELLMs to identify the type of content within each ELLM, input question, ensemble model, ELLM selection modules, cost and accuracy data associated with each ELLM and LLM, answers obtained via use of any combination of ELLMs and LLMs, golden answer, confidence scores and threshold, granularity level of evaluation, and machine learning data, and NLP, ML, and AI algorithms and all the functionalities and processes discussed herein. Cloud-based storage, described in relation to FIG. 3, may be used to supplement the storage 308 or instead of the storage 308.

The control circuitry 304 may include audio generating circuitry and tuning circuitry, such as one or more analog tuners, audio generation circuitry, filters or any other suitable tuning or audio circuits or combinations of such circuits. The control circuitry 304 may also include scaler circuitry for upconverting and down converting content into the preferred output format of the electronic device 300. The control circuitry 304 may also include digital-to-analog converter circuitry and analog-to-digital converter circuitry for converting between digital and analog signals. The tuning and encoding circuitry may be used by the electronic device 300 to receive and to display, to play, or to record content. The circuitry described herein, including, for example, the tuning, audio generating, encoding, decoding, encrypting, decrypting, scaler, and analog/digital circuitry, may be implemented using software running on one or more general purpose or specialized processors. If the storage 308 is provided as a separate device from the electronic device 300, the tuning and encoding circuitry (including multiple tuners) may be associated with the storage 308.

The user may utter instructions to the control circuitry 304, which are received by microphone 316. The microphone 316 may be any microphone (or microphones) capable of detecting human speech. The microphone 316 is connected to the processing circuitry 306 to transmit detected voice commands and other speech thereto for processing.

The electronic device 300 may include an interface 310. The interface 310 may be any suitable user interface, such as a remote control, mouse, trackball, keypad, keyboard, touch screen, touchpad, stylus input, joystick, or other user input interfaces. A display 312 may be provided as a stand-alone device or integrated with other elements of the electronic device 300. For example, display 312 may be a touchscreen or touch-sensitive display. In such circumstances, the interface 310 may be integrated with or combined with the microphone 316. When interface 310 is configured with a screen, such a screen may be one or more monitors, a television, a liquid crystal display (LCD) for a mobile device, active-matrix display, light-emitting diode display, organic light-emitting diode display, quantum-dot display, or any other suitable equipment for displaying visual images. The speaker (or speakers) 314 may be provided as integrated with other elements of electronic device 300 or may be a stand-alone unit. In some embodiments, the display 312 may be outputted through speaker 314.

The equipment device 300 of FIG. 3 can be implemented in system 200 of FIG. 2 as electronic equipment device 202, but any other type of user equipment suitable for allowing communications between two separate user devices for performing the functions related to implementing machine learning (ML) and artificial intelligence (AI) algorithms, and all the functionalities discussed associated with the figures mentioned in this application

The electronic device 300 of any other type of suitable user equipment may also be used to implement ML and AI algorithms, and related functions and processes as described herein. Various network configurations of devices may be implemented and are discussed in more detail below.

FIG. 4 is flowchart of an example of a process for obtaining enterprise data and generating and training enterprise LLMs (ELLMs), in accordance with some embodiments of the disclosure.

Process 400 may be implemented, in whole or in part, by systems or devices such as those shown in FIGS. 2-3. One or more actions of process 400 may be incorporated into or combined with one or more actions of any other process or embodiments described herein. Process 400 may be saved to a memory or storage (e.g., any one of those depicted in FIGS. 2-3) as one or more instructions or routines that may be executed by a corresponding device or system implementing process 400.

In some embodiments, at block 410, the control circuitry, such as the control circuitry 228 and/or 220 of system 400 in FIG. 4, may access enterprise data to obtain and analyze the enterprise data and use it as training data for an ELLM.

In some embodiments, the control circuitry 228 and/or 220 may access a range of enterprise databases, including central servers, department-specific storage (like HR servers), and any other data repositories.

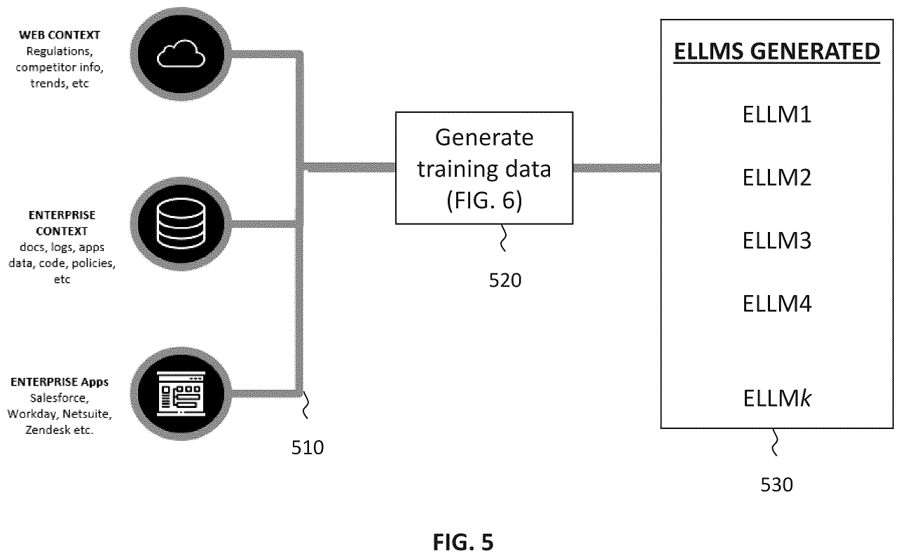

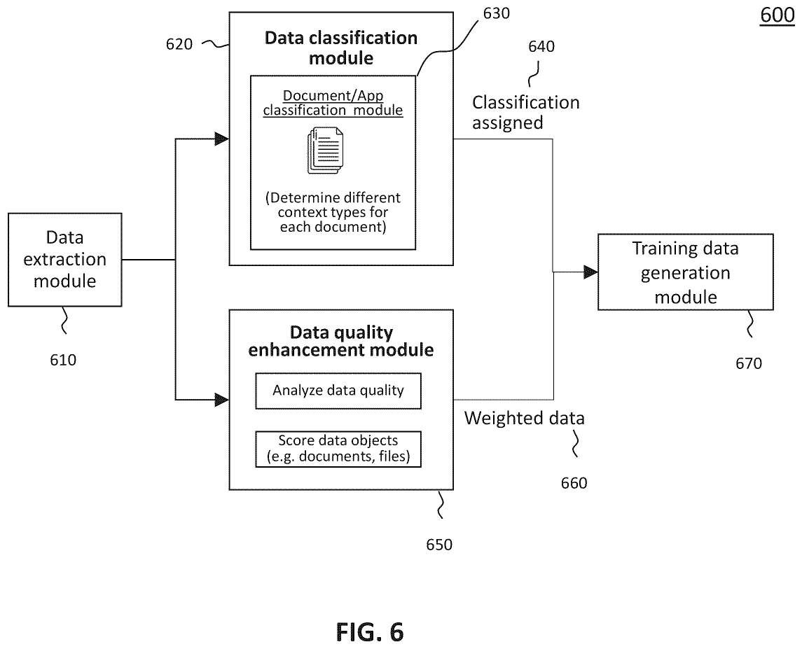

In some embodiments, data may be stored within applications, such as Salesforce's desk.com™ application that offers a help desk ticketing related solution or Oracle's NetSuite™ that allows businesses to gain customer insights. The application may be sales related, or they may be marketing, engineering, facilities, management, or finance related. In some instances, the application may be solely used by a single department at the company and in other instances the application may be used by multiple departments. Applications may also include a plurality of features, some of which may be used by one department and other features may be used by another department. In yet other embodiments, data, such as web context data may be stored in the cloud (e.g., public or private cloud). Examples of such data may include regulations, competitor information, etc. Enterprise context data, such as documents, logs, applications, code, policies, employee profiles, employee job titles and roles, employee performance reviews, conference call recordings, etc. may be stored in servers, databases, platforms, storage devices. Data relating to enterprise applications may also be stored at servers, databases, platforms, and storage devices. Although some examples are described where enterprise data may be stored, these examples are non-limiting and data may be found and stored in numerous locations and servers, databases, platforms, storage devices, and on online platforms. All such data may be accessed by the control circuitry to obtain, analyze, curate for quality, classify and use it as training data for an ELLM. Additional examples of enterprise resources from where data can be accessed are provided in FIGS. 5-6.

In some embodiments, the control circuitry 228 and/or 220 may require authorization to access the data. As such, a determination may be made at block 420 if such an authorization is needed. Since some databases, servers, storage devices in the enterprise may store confidential, proprietary, and even top company secrets, it may not be desirable to provide access to all the data for use in training an ELLM. In other embodiments, access may be provided to all the data, however, as will be described in further detail below, access may be restricted depending on which user is asking the question, or which user seeks information and what level of clearance is allotted for that particular user.

If a determination is made at block 420 that an authorization is needed, then at block 425, authorization may be requested and obtained. If authorization is denied, then the control circuitry 228 and/or 220 may not be able to access and use data from such databases or storage devices and the control circuitry 228 and/or 220 may skip and move on to other servers, databases, storage devices and the like to access and use enterprise data.

At block 430, the control circuitry 228 and/or 220 may extract data from all the servers, such as email servers, department servers, executable applications, document libraries, databases, employee files stored on local or shared drives, and any storage used by the enterprise or an employee of the enterprise for storing data for which authorization is provided. Extracting data may be performed by the control circuitry by using existing techniques such as extract, transform, and load (ETL) techniques and extract, load, transform (ELT) techniques. Data may also be extracted by the control circuitry by using crawlers, scraping software tools, API integration, data mining, database querying, text pattern matching and other types of large data extraction techniques. Data may also be obtained from other existing LLMs and ELLMs.

At block 440, the data accessed may be classified into categories. In some embodiments, enterprise data may be categorized based on its relevance to specific departments. Data may be classified into single or multiple departments, depending on its applicability. For instance, financial data related to a product might be classified under sales, marketing, and finance. Data classification may be hierarchical, involving classes, subclasses, and further subdivisions. There may be various tiers of classes and subclasses depending on the applicability and use of such data. The process of classifying data is further described at least in the description of FIG. 6.

At block 450, a determination may be made whether a data object, such a document, file, application, image, video, etc., has multiple sections relating to different contexts. For example, an internal company report may provide details relating to several departments in a company. In such a scenario, in one embodiment, the entire document may be classified for all the departments that are addressed in the company report. In another embodiment, as depicted at block 455, each section of the document may receive a different classification depending on its relationship and applicability to a department. The control circuitry 228 and/or 220 may classify data objects by analyzing them in sections, parts, or segments, based on contextual relevance. General classifications may be used for data applicable to multiple company departments.

At block 460, the control circuitry 228 and/or 220 may determine the data quality of the data extracted at block 430. Determining data quality may include the control circuitry 228 and/or 220 analyzing each data object based on one or more factors. The factors used may include validity, versions, draft vs final, errors, comments associated with the data object, whether it is used commonly, whether the data object resides in personal files of enterprise databases, document updating policies, and references by C-suite to name a few. These and other factors used by the control circuitry 228 and/or 220 to analyze data quality of a data object and generate a weighted score for the data object is discussed further at blocks 650 and 660 of FIG. 6.

At block 470, once the data has been classified and curated for quality, such data may be used by the control circuitry 228 and/or 220 to generate K number of ELLMs. This number may vary depending on the enterprise and the amount of data and classes. For example, some enterprises may have 10 ELLMs while others may have 5,000 ELLMs. The enterprise may also provide a predetermined limit to a number of ELLMs that are to be created, and such limitations may be followed in creating the ELLMs. The ELLMs generated may then be trained at block 480 using the classified and quality curated data. Training the ELLMs may be a continuous process where new data generated is accessed, classified, curated and then added to train the generated ELLMs. In other embodiments, the training updates may be on a periodic basis instead of on a continuous basis. Other rules for accessing additional data and using it to train the generated ELLMs may also be applied.

FIG. 6 is a block diagram of an example for determining data classification and curating data quality for its use to train the ELLMs, in accordance with some embodiments of the disclosure.

In some embodiments, a system for generating training data, such as the system 200 in FIG. 2, may further include a data extraction module 610, a data classification module 620, a data quality enhancement module 650, and a training data module 670. In some embodiments, the modules may be separate from each other and in other embodiments a single module may be able to perform all the functions performed by each of the mentioned modules. Although some examples of modules have been described, the embodiments are not so limited and any other type of module, or less and more modules, may also be used to perform similar functions as described in FIG. 4.

In some embodiments, the data extraction module 610 may be invoked by the control circuitry 228 and/or 220 to extract data from enterprise resources and data storage locations, such as the enterprise resources 510 described in FIG. 5.

The data extraction module 610 once invoked, may extract data from all enterprise resources and data storage locations, such as enterprise servers, such as email server, department servers, executable applications, document libraries, databases, employee files stored on local or shared drives, and any storage used by the enterprise or an employee of the enterprise for storing data. The data extraction module may use techniques such as extract, transform, and load (ETL) techniques and extract, load, transform (ELT) techniques to extract date from the enterprise resources and storage locations. It may also use crawlers, scraping software tools, API integration, data mining, database querying, text pattern matching and other types of large data extraction techniques to extract data from all enterprise resources and data storage locations used by the enterprise, including from other existing ELLMs.

Once data has been accessed, extracted or obtained, the data classification module 620 may be invoked to classify the extracted data. In other words, the data classification module 620 may organize the extracted data into classes and subclasses. The data classification module may further classify data into several tiers of classes and nested subclasses within a broader class. To classify the extracted data, the data classification module may tag the extracted data to make it easily searchable and trackable. The tagging may be based on the type of data, its relevance to a particular department, its sensitivity, its business value, etc. Tagging may also be implemented based on other desired factors or recommendations, such as a specific category of data that the company wants easy access to for performing a critical company function. Tagging may be automatic without any user intervention and in other embodiments it may be user assisted or supervised.

The data classification module 620 may review each piece of data extracted from by the extraction module 610 and determine its context and applicability. For example, if a document includes employment details, or is a document that is an employee handbook, employee vacation policy, employee review, employee compensation, etc., then analyzing the content and the context the data classification module 620 may determine that it should be classified as a human resources document. As such, a human resources or HR tag may be added to that piece of data. The data classification module 620 may further determine that even within HR, employee compensation should be classified as its own category since that is used specifically for hiring and retention and may be used by a specific group within HR. If such a sub-classification is useful within the enterprise, then the data classification module 620 may generate a tag for such a nested sub-class.

Organizing data into such classes and subclasses, including layers of nested tiers and classes, may make data easier to locate and retrieve, especially data that is very specific or niche and is of particular importance to answer certain queries. Such classification may also provide full visibility into the various classes of data included in the enterprise.

The data classification module 620 may also use existing classification techniques to classify the extracted data. For example, the data classification module 620 may use a supervised machine learning method to determine an appropriate tag of a data object extracted. The supervised machine learning method may be trained to analyze data and suggest a classification tag which then may be approved, denied, or modified as needed.

In some embodiments, each data object, such as a document, email, text message, audio file, video file, image, application, file, or any other type of data object in its entirety may be tagged with a single classification. In other embodiments, the data object may relate to multiple departments, functions, applications within the enterprise and as such may be tagged with multiple classifications or sub-classifications.

In other embodiments, data objects, such a document, file, application, image, video, etc., may have multiple sections which have different content and context. As such, each section may be analyzed by a document/app classification module 630 that is associated with the data classification module 620 and each section may receive a separate classification. In such an embodiment, the overall data object in its entirety, such as a word document, may receive a certain classification and sections within the document may receive different classifications. As depicted at block 640, the data classification module 620, may assign the classification and/or sub-classification to each data object that is associated with the enterprise and is extracted by the data extraction module 610.

Once data has been accessed, extracted or obtained by the data extraction module 610, the data quality enhancement module 650 may be invoked to curate data quality. Ensuring that enterprise data extracted by the data extraction module 610 is of good quality, high quality, reliable, and complete and accurate may be of high importance to an enterprise. This is because the extracted data may be used to generate and train ELLMs that essentially may be used to make key business decisions, maintain market leadership by staying ahead of competition, make day-to-day decisions in a department, or used for any business purpose. As such, curating data for its quality ensures that accurate, reliable, and complete data that is not outdated is being used by the enterprise and its employees when using ELLMs that are trained on such data to obtain responses relating to their work and the enterprise.

Accordingly, the data quality enhancement module 650 may analyze data quality and score each data object (e.g., document, email, text message, audio file, video file, image, application, file) according to its quality. The process of analyzing may include the data quality enhancement module 650 analyzing each data object based on one or more factors. The factors used may include validity, versions, draft vs final, errors, comments associated with the data object, whether it's used commonly, whether the data object resides in personal files of enterprise databases, document updating policies, and references by C-suite to name a few.

Data objects may be weighed against these and other factors and a weighted score for each data object may be generated. In some embodiments, data object scoring may be performed by weighing various attributes to determine relevance and validity. For example, an expired or soon-to-expire data object may receive a lower score compared to a current, long-dated one. Similarly, older or draft versions may be scored lower than current or final versions. Documents with errors, redline markups, or editing comments may be penalized, while those with corrections receive higher scores. Data objects praised by managers or C-suite employees may receive elevated scores, reflecting their perceived value. Data objects stored in personal folders may be weighted less than those residing in enterprise storage, emphasizing the increased authenticity and accuracy associated with widely used, company-stored data. Although some embodiments of analyzing data quality and generating a weighted score have been described, these embodiments are non-limiting and other types of data analysis to generate a weighted score are also contemplated. For example, the data quality enhancement module 650 may use a formula, or recommendation from an artificial intelligence (AI) engine to determine data quality of a data object and generate its weighted score, such as the weighted score depicted at block 660.

Once data has been classified, as depicted at blocks 620-640, and curated for quality and scored, as depicted at blocks 650 and 660, the data may then be used as training data by the training data generation module 670.

Once data has been classified and curated for quality, in some embodiments, the system, such as system 400, may use the data classifications generated at block 620-640 to generate ELLMs for each such classification. In other embodiments, the system may generate ELLMs only for the top tier classes or the top tier and the first layer of subclasses and not for all the nested tiers. In yet other embodiments, all nested classification tiers may be used to generate an ELLM structure that mimics the class and sub-class nested tiers. In another embodiment, a predetermined number of ELLMs may be generated and in yet another embodiment, a formula or a recommendation from a recommendation engine, such as an AI engine, may be used to determine the number of ELLMs to generate. Each ELLM generated may then be trained using data curated and scored by the data quality enhancement module 650. Training the ELLMs generated, such as the k number of ELLMs, would allow the ELLM to continuously, or at periodic intervals, learn and advance based on the continuous input of training data such that it stays current, accurate, relevant, and reliable in responding to query posted to it. It may also be trained based on the judge's recommendations and insights of any error and inconsistencies that cause a below confidence threshold performance. In some embodiments, the ELLMs described above may be generated and stored prior to receiving a query from the user. In other embodiments, the ELLMs may be dynamically generated based on training data 670 based on the identity of the user and context and/or category of the query input.

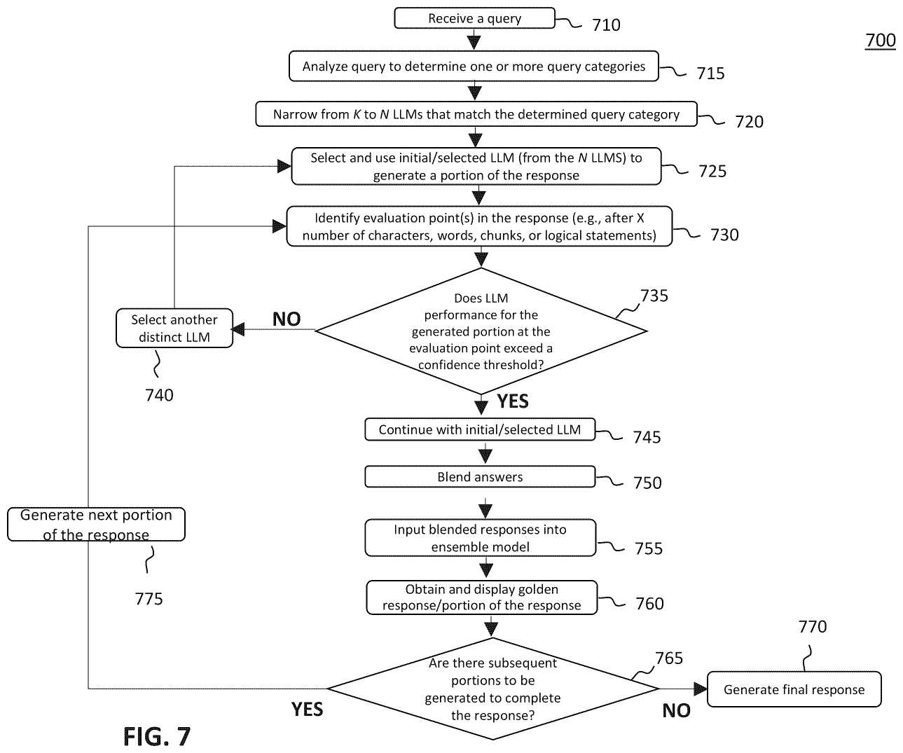

FIG. 7 is flowchart of an example of a multi-layer process for selecting a plurality of language models, applying combining and cascading techniques, and obtaining a curated/enhanced response, in accordance with some embodiments of the disclosure.

In some embodiments, process 700 may be implemented, in whole or in part, by systems or devices such as those shown in FIGS. 2-3. One or more actions of process 700 may be incorporated into or combined with one or more actions of any other process or embodiments described herein. Process 700 may be saved to a memory or storage (e.g., any one of those depicted in FIGS. 2-3) as one or more instructions or routines that may be executed by a corresponding device or system to implement process 700.

In some embodiments, at block 710, a query is received by an artificial intelligence (AI) generative system. The query may range from simple questions and code requests to complex document generation tasks.

At block 715, the query may be analyzed to determine one or more categories for the query. The AI system may decompose the query into tractable tasks, sub tasks, problems, subproblems, while simultaneously classifying it across a high-coverage categories/taxonomy. This may be performed to enable downstream routing and confidence modulation to adapt according to the task's domain, complexity, modality, and other salient characteristics.

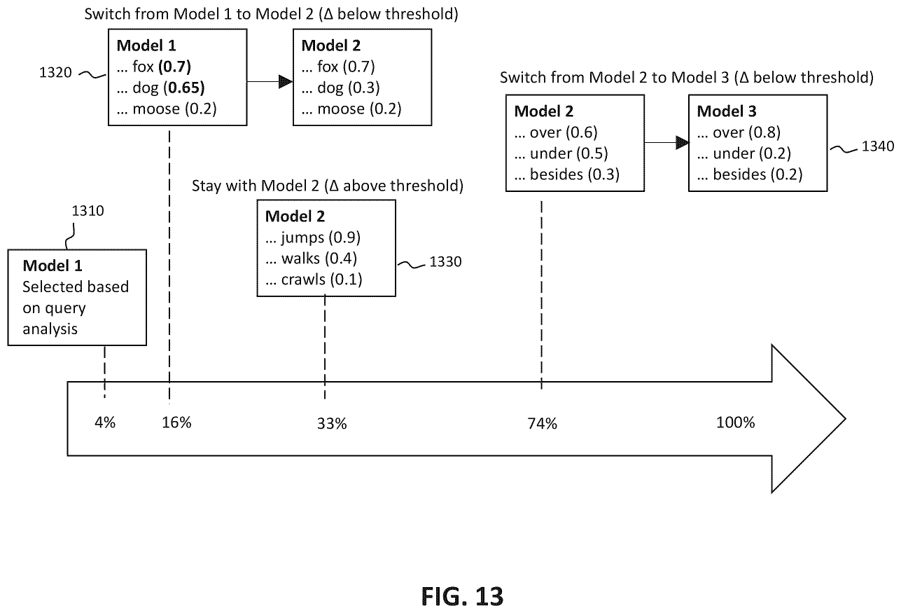

In some embodiments, the query may be analyzed to determine its context, intent, format, presentation, requirements, etc. The analysis results may be used to categorize the query as a whole or portions of the query, into various categories, such as a task group category. In other embodiments, it may be categorized based on its reasoning types, NLP/coding tasks, input/output requirements, complexity of tasks, domain, and other category types, as further described in FIG. 13. The analysis and categorization of the query may be performed by an LLM.

As referred to herein, the task group category may include, but is not limited to, instruction following, knowledge context reasoning, quantitative analytical reasoning, each of which may have multiple subcategories (e.g., mathematical problem solving, long document analysis). For example, a query that provides instructions to perform a task may be categories under a task group since it's a query that requires following instructions.

Likewise, reasoning type categorization may relate to capturing logical properties such as deductive, multi hop, or domain specific reasoning. For example, a query that requires reasoning based on a domain, such as determining power consumption for a circuit that may require deductive reasoning based on the amount of current in the circuit may be categorized under a reasoning type category since it requires deductive reasoning from a specific domain, e.g., electrical engineering. NLP/coding categories may relate to cataloging transformations, generations, or code manipulation requirements. Input/Output requirements category may relate to specifying the input/query's input formats (plain text, JSON, code) and expected output style (short-text, code-snippet, markdown, etc.). Complexity category may relate to complexity levels, indicating whether the input/query or prompt requires low, moderate, or high complexity reasoning and context management. Domains may refer to specific specialization, such as in the fields of healthcare, medical, legal, retail ecommerce, etc., ensuring domain-specific knowledge or constraints are recognized.

Analyzing the query, in some embodiments, may involve using any one or combination of Natural Language Processing (NLP), AI, or machine learning (AI/ML) techniques. NLP may be used to interpret the text or voice input, e.g., when the user voice inputs the query, to understand the query's content and context and even user sentiment, which may be determined based on sentiment analysis to determine the user's emotional state, allowing for customized responses. For instance, AI may determine whether the user is a frustrated user and may generate a different solution than for a first-time inquirer. AI/ML engines may be used to enhance query analysis by executing algorithms that provide recommendations on the query's true intent, its classification, granularity that may be used when evaluating a response to the query, and relevant enterprise departments to consider in selecting a language model. Such an analysis may be used to deliver a more accurate and contextually appropriate response.

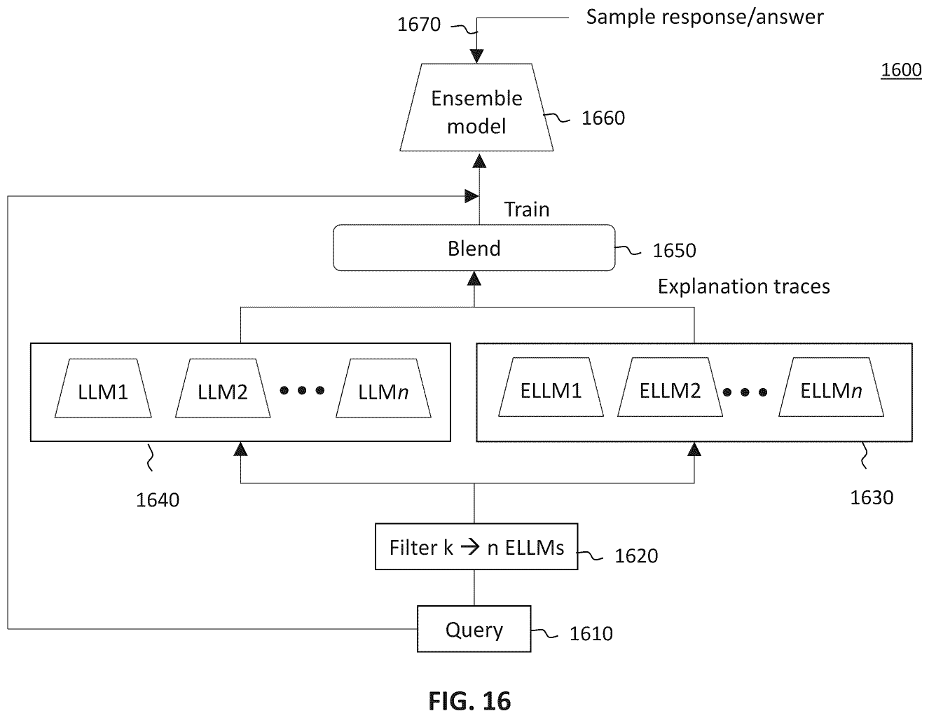

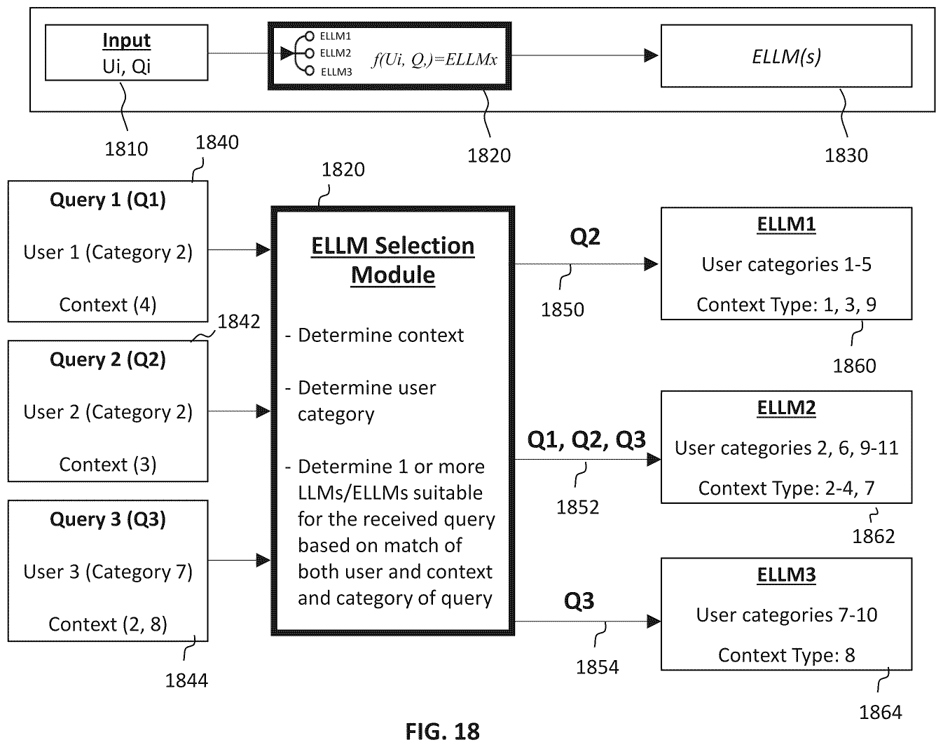

At block 720, also depicted at block 1620 of FIG. 16, the AI generative system, such as the system shown in FIG. 2 via its control circuitry 228 and/or 220 may narrow the number of ELLMs from k ELLMs to n ELLMs, where k is a larger number than n. Some embodiments of narrowing from k ELLMs to n ELLMs are described further in the description related to FIGS. 18-22, 26A-C, and 27-28.

In some embodiments, one or more factors may be analyzed in the narrowing process. One such factor used may be the content and context of the query (also referred to as question or task) received at block 710. In some embodiment, an enterprise may have k number of ELLMs, each ELLM relating to a specific function of the enterprise or a specific department, such as engineering, human resources etc. If results from analyzing the content and context of the query at blocks 710-720 indicate that the query is related to finance, then control circuitry 228 and/or 220 may narrow the k number of ELLMs to only those ELLM that relate to finance. Since context and content of the query received may apply to more than one topic and as such to more than one ELLM, any ELLMs that is available for use and connected to the topic, either the entire query or a portion of the query, may be included in a set of the narrowed n ELLMS.

In yet another embodiment, even within a department of an enterprise or within an ELLM that has been trained with data relating to a specific function, there may be nested or further specific ELLMs that relate to different subtopics or categories within the larger category of the ELLM. For example, an ELLM may be broadly trained with engineering data (i.e., larger category) and further nested or subtopics of ELLMs, such as mechanical engineering, electrical engineering, computer science, may exist within the broader engineering ELLM. In another example, an ELLM may be broadly trained with HR data and sub-categories of resumes, background checks, compensation, HR policies, promotions, employee reviews, benefits, which may be topics under the broader HR umbrella, may each have a specific ELLM under the broader HR ELLM. In such embodiments, the process of narrowing from k number of ELLMs to n number of ELLMs may include not including those specific ELLMs that do not relate to the content and context of the query received. Continuing with the above example, in some embodiments, if the content and context of the query received relates to HR policies, then the control circuitry 228 and/or 220 may only include the ELLM that relates to HR policies in the narrowed set of n ELLMs. In another embodiment, the control circuitry 228 and/or 220 may select a set of nested ELLM that relates to HR policies as well as the broader ELLM that relates to HR in the narrowed set of n ELLMs. The system may also exclude other ELLMs that are nested underneath the broader HR ELLM but do not relate to HR policies, such as compensation or employee reviews, from the narrowed set of n ELLMs.

In some embodiments, another factor analyzed to narrow the k number of ELLMs to n number of ELLMs may include the identity of the user from whom the query is received. In an enterprise setting, the user may be a CEO, VP, manager of a specific department, an associate, a new hire, a consultant that has been hired for a short duration to work on a specific project, or another category of employee. Since the level of access to confidential and proprietary enterprise data may vary from user to user, the control circuitry 228 and/or 220 may determine the identity of the user, their authorized level of access to confidential and proprietary enterprise data and include only those ELLMs to which the user is allowed access. For example, an associate may be authorized to access lower level confidential and proprietary enterprise data, a contractor may not be authorized to access any confidential and proprietary enterprise data, and a CEO may have the highest level of authorization to access any and all confidential and proprietary enterprise data. In another example, a manager in an engineering department may be authorized to access all engineering data but not any data from the finance department. Such user identity and their authorization levels may be considered and only those ELLMs that have been trained with data to which the user is allowed access may be retained in the narrow set of n number of ELLMs.

In some embodiments, both a combination of the content and context of the query and the user identity together may be considered in narrowing from k number of ELLMs to n number of ELLMs. In some embodiments, first the context of the query may be used to narrow from k number of ELLMs to n number of ELLMs and then the remaining ELLMs may be further narrowed based on the user identity. In other embodiments, first the user identity may be used to narrow from k number of ELLMs to n number of ELLMs and then the remaining ELLMs may be further narrowed based on the content and context of the query. In yet another embodiment, some combination of both the content and context of the query and the user identity may be used to narrow from k number of ELLMs to n number of ELLMs. In yet other embodiments, the control circuitry 228 and/or 220 may place certain weights on which factor to consider more in the narrowing process. In some embodiments the control circuitry 228 and/or 220 may place a higher weight on user identity than the content and context of the query and in other embodiments the control circuitry 228 and/or 220 may place equal weight on both user identity and the content and context of the query in the narrowing process. Although user identity has been discussed above in terms of the user's association with a department, type of job role, level of access provided to confidential and proprietary data, the user's contractor or employee status, and various other enterprise related contexts as described herein, the embodiments are not so limited. In other embodiments, user identity may also be used to establish the proficiency or level of understanding of a user. For example, an engineer with 2 years of experience and an engineer who is head of the department or has several years of engineering experience may have different levels of understanding. As such, the systems may also take into consideration the user's identity with respect to level of understanding to select an appropriate LLM or ELLM or further in the process to blend answers from different ELLMs and/or LLMs that is suitable for the level of understanding of the specific user.

In some embodiments, another factor analyzed to narrow k number of ELLMs to n number of ELLMs or from a k number publicly available LLMs to n number of publicly available LLMs may include cost of processing. In this embodiment, each LLM may have a cost of processing associated with it. The cost may vary from one LLM to another LLM and may be dependent on many factors, such as cost of computing to produce a response or an answer to the query presented in a chat box. For example, relating to public LLMs, a same query presented to ChatGPT™, Bard™, Llama™, Bing chat™, Claude™, and Jasper™, may result in different costs to the user. In this embodiment, the user may provide a upper limit for the cost, or a cost window, or some other cost related criterion. Accordingly, the reduction from k number of ELLMs to n number of ELLMs or from the k number of publicly available LLMs to n number of publicly available LLMs may be based on the user provided cost parameters. In other embodiments, the system may automatically select the least cost alternative and use an LLM that has the least cost associated with providing the answer.

In some embodiments, another factor analyzed to narrow k number of ELLMs to n number of ELLMs or from a k number of publicly available LLMs to n number of publicly available LLMs may include accuracy. In this embodiment, each user may determine the level of accuracy they desire for a response or an answer to a query they presented in the input area of an LLM chatbot. A user may be willing to live with an average or low level of accuracy for simple queries, such as a middle school math problem or for writing a thank you letter and desire a high level of accuracy for critical problems. For example, if the query posed to the LLM is desiring to seek a solution that would impact a company's sales, a job prospect, debugging of a bug in critical software, then the user may desire a higher level of accuracy and be willing to pay for the higher level of accuracy. Since accuracy may relate to computing power, e.g., a higher level of accuracy for a complex problem requiring higher usage of computational resources and thereby incurring more costs, the user may reserve a higher level of accuracy for more important and critical tasks. Accordingly, in an example where accuracy parameters are described and the query is presented to LLMs such as ChatGPT™, Bard™, Llama™, Bing chat™, Claude™, and Jasper™, the system may narrow the selection of the LLMs based on the accuracy parameters.

In yet other embodiments, both cost and accuracy collectively may be balanced to narrow k number of ELLMs to n number of ELLMs or from a k number of publicly available LLMs to n number of publicly available LLMs. In this embodiment, the user may define their cost and accuracy parameters, and the system may narrow the k number of ELLMs to n number of ELLMs or from a k number of publicly available LLMs to n number of publicly available LLMs based on the provided parameters. In other embodiments, the system may analyze cost Vs accuracy for an ELLM or an LLM to provide a response to a query. The system may automatically determine the content, context, and category of the query and based on such determinations generate the costs and accuracy parameters. These generated parameters may then be used by the system to narrow the number of ELLMS and/or LLMs. The system may also determine a pattern of use by the user that is seeking a response to the query. Machine learning (ML) engines that execute ML algorithms may be utilized by the system to detect a user behavior pattern with respect to cost and accuracy parameters used by the user previously. The user behavior pattern determined may show that the user selected a first set of cost and accuracy parameters for one type of query and a second set of cost and accuracy parameters for a second type of query. Accordingly, the system may match a new query to the pattern to select from different sets of parameters and then narrow the set of LLMs and/or ELLMs based on the generated parameters. In another embodiment, the system, using data obtained from ML algorithm, may determine a relationship between cost and accuracy parameters, complexity of query, importance of query, and what parameters were previously used based on different levels of complexities and importance of the query. The system may use the determined relationship to generate cost and accuracy parameters to select an LLM for a current posed query.

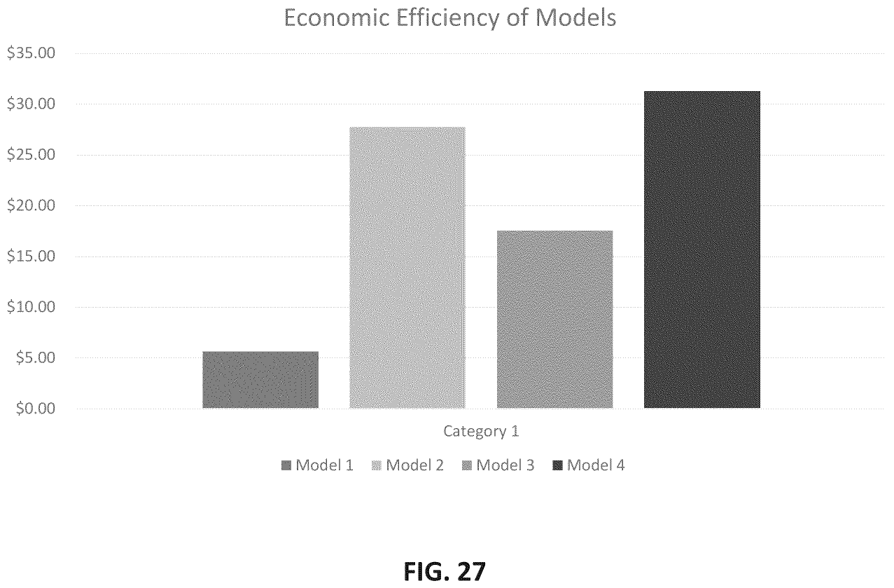

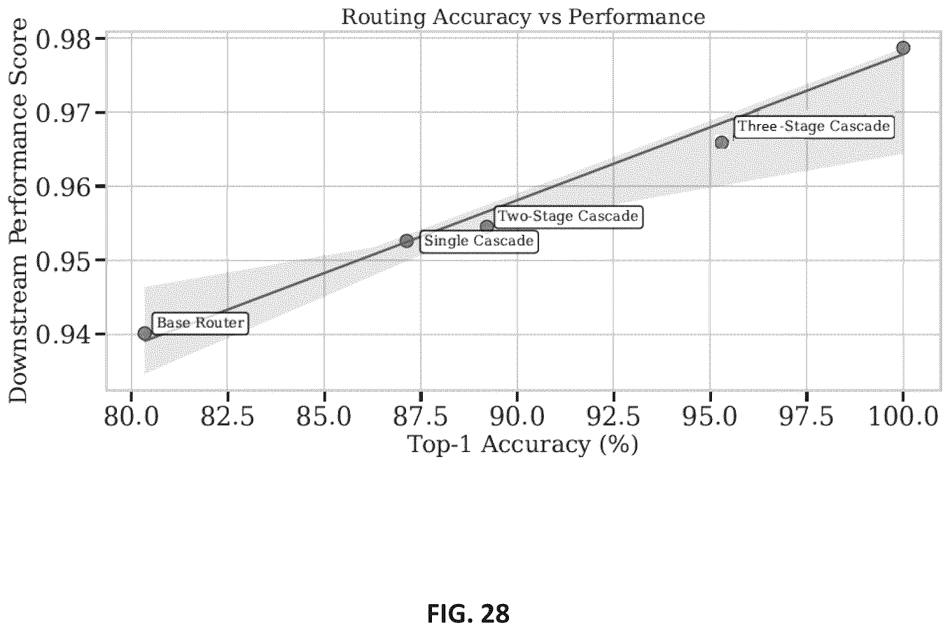

In some embodiments, the system may analyze a cost and accuracy trade-off. In other words, since higher accuracy may require more computational processing power thereby incurring more costs, the system may determine whether there is a benefit to incur higher costs based on the type of query asked and the importance of the query. Some examples of the cost, accuracy, and combination used to narrow the number of LLMs (or ELLMs) are depicted in FIGS. 26A-C and 27-28. In FIG. 26A, LLMs 1-4 may provide a costs basis for answering the same query input into the LLM. For example, to provide a response to the same query, LLM2 may have the lowest cost basis of 2.8 while LLM4 may have the highest cost basis of 3.9. The system, or the user, may narrow the number of LLMs (or ELLMs) based on the costs and select, for example, LLM2 since it has the lowest costs. The system, or the user, may also select the two (or other number) lowest LLMs (or ELLMs) based on costs. Similarly, in FIG. 26B, LLM7 may provide the highest accuracy and as such may be selected. In other embodiments, the top two, three, or other number of highest accuracy producing LLMs may be selected. FIG. 26C depicts selection of an accuracy level based on the importance of the query to the user. A query that is very important, such as query 2 (Q2) having an importance level 8 associated with it, on a scale of 10, may be suitable for an LLM that provides 93% accuracy. On the other hand, a query of lower importance, such as Q1 may be suitable for an LLM that provides 62% accuracy. Although references to tables and LLMs are made in FIGS. 26A-C, the embodiments include ELLMs and other formats of data, such as in charts, graphs, histograms, and other formats may also be used. In FIG. 27, economic efficiency of the ELLMs and in FIG. 28, routing accuracy and performance may be factored in selecting the ELLMs. This selection may be for the section of the LLM, ELLM, or combination thereof, at the initial stage of selecting a model or anytime through the response process when cascading/switching is performed to switch to another model due to an earlier model performing below a threshold confidence level.

Although costs and accuracy have been discussed in terms of different LLMS and ELLMS, the embodiments are not so limited and apply to a single LLM or ELLM. For example, a single LLM may provide different levels of accuracy at different costs. In such an embodiment, the user (or system) may specify the costs or accuracy parameters and when the LLM reaches the provided parameters it may stop further processing and provide the best answer that can result based on the cost or accuracy parameters provided.

In some embodiments, the system may determine the economic efficiency of models, as depicted in FIG. 27 to narrow from k number of ELLMs and narrow them to n number of ELLMs. For example, as depicted in the figure, Model 1 may cost $5 for generating responses for 1000 queries, model 2 may cost $27.00 for generating a response for the same number of queries, i.e., 1000 queries, model 3 may generate the 1000 queries for $16.00, and model 4, which may be the most expensive model, may generate a response for 1000 queries at $32. If economic efficiency is deemed important based on the type of query, in some embodiments, Model 1, which is the cheapest model for responding to 1000 queries, or generating 1000 responses, may be selected. In other embodiments, if model 2 or model 4, although they cost more, generate a response with the higher accuracy, and higher accuracy is deemed important based on the type of query, then economic efficiency may be sacrificed, and accuracy may be selected as a priority to then select one of those models with higher accuracy. It may all depend on which metric, such as cost, efficiency, accuracy, and other metrics discussed herein, are deemed important based on the type of query received.

In some embodiments, to optimize cost and efficiency, the control circuitry 228 and/or 220 may use a tiered model selection strategy. This strategy may involve the control circuitry 228 and/or 220 utilizing smaller, more specialized LLM models, designed for niche tasks as a starting point and if the smaller LLM models fail, e.g., their confidence scores are below a threshold, then the control circuitry 228 and/or 220 may incrementally move to larger and larger models, one after another, or more advanced LLM models. This control circuitry 228 and/or 220 may continue to cascade between models and move to larger, more advanced until the response to the query is successfully completed. In some embodiments, if all models fail, the query may then be routed by the control circuitry 228 and/or 220 for human feedback to facilitate further iteration and improvement. However, if the training process reveals that a larger, more powerful model consistently excels at handling complex, multi-domain tasks that cannot be effectively broken down, then the control circuitry 228 and/or 220 may directly select such a model for responding to the query. When cost is an important factor, the control circuitry 228 and/or 220 may start with the most niche models, which may have a specialty, domain expertise, and if the performance falls below the confidence threshold, then the control circuitry 228 and/or 220 may move to larger models that may cost more for a response.

In some embodiments, the system may determine a balance between the routing accuracy and performance, as depicted in FIG. 28 to narrow from k number of ELLMs and narrow them to n number of ELLMs.

In addition to ELLMs, the control circuitry 228 and/or 220 may also determine k number of publicly available LLMs and narrow them to n number of LLM. The control circuitry 228 and/or 220 may perform the narrowing process by determining which LLM relates to the content and context of the query received, similar to the process used for the ELLMs.

In some embodiments, two approaches may be used in selecting the initial LLM model for responding to the query. In a first embodiment, when a query's category is discernible, such as based the type of query, prior knowledge, the query type having been seen before by the control circuitry 228 and/or 220, or the category being specified by the user, an LLM, or the AI system, then, a full categorization procedure, as described in blocks 715 and 720 may be bypassed. In these instances, the control circuitry 228 and/or 220 may directly select the best or most optimal LLM model from the k number of ELLMs or n number of ELLMs that matches the category of the query. This approach leverages high confidence matches, wherein the evaluation and training phases have clearly identified LLM models for specific, predictable query types, such as NLP/Coding query which may be discernable based on the language used in the query (e.g., generate a code, use C++ to write a script, etc.). By recognizing these attributes, the control circuitry 228 and/or 220 may route the query directly to the one or more identified suitable LLMs and avoid using resources for identifying an LLM to be used.

In another approach, when the query's category is ambiguous or cannot be readily identified, a learned routing model may be used. Using this approach, the control circuitry 228 and/or 220 may perform the analysis and classification of the query into categories and then use that category to match the best LLM model for use. As such this approach may involve a more complex analysis of the query to classify it, followed by the application of a learned router to select the most appropriate LLM. The learned router used may predict the performance of potential LLM that may be selected and score them based on the prediction. The scoring may relate to the learned touter's assessment of how well the potential LLM may perform responding to the received query. In some embodiments, the learned router approach may be used for handling queries with latent values or complex characteristics that require a nuanced understanding to determine the optimal model.

In some embodiments, certain methodologies may be used when utilizing a learned routing model. These methodologies may include formulating the query as direct performance prediction rather than similarity matching, which may yield more interpretable scores. Another methodology used may be to apply normalization techniques to address the heterogeneous score distributions across different models. Yet another methodology used may be to integrate categories into the learned router to enrich the query representation with contextual information. This methodology may allow for a more accurate and efficient selection of LLMs, enabling the selected LLM model to handle a wide range of queries, including those with ambiguous or out-of-distribution characteristics.

At block 725, once the number of ELLMs have been narrowed down to an n number of ELLMs, then one or more ELLMs, from the n number of ELLMs, that match a category with the determine category of the query may be selected for generating a response to the query. The response generated by the one or more selected ELLMs may be generated and displayed on a user interface of the user on a segment-by-segment basis, in real-time, as the model continues the progressive generation of them until the full response is completed. For example, a complete response that is to be generated may be “See the code in python for automating verification of employee's vacation hours.” The segments referred to herein may be characters, plurality of characters, partial words, complete words, phrases, chunks of words or phrases, or the entire query. In this example, if the segments are to be construed as words, then the sentence “See (1) the (2) code (3) in (4) python (5) for (6) automating (7) verification (8) of (9) employee's (10) vacation (11) hours (12),” in its entirety may represent 12 segments. If the segments are to be construed as letters or alphabets, then each character, such as in the word “See,” may include 3 characters or alphabets. Likewise, chunks may be defined by the combination of a sequence of 2 words, 3 words, or any set number of words. Larger segments may be complete sentences or logical and coherent thoughts that form a portion of the complete response, which may be, in some instances, as long as a paragraph, page, or several pages.

At block 730, one or more points, locations, may be predetermined in the response for verification. For instance, the AI generative system may require that segments are to be construed on a word-by-word basis for this response and accordingly, as the words of the response are generated and displayed, the analysis and evaluation may take place. To perform such an evaluation, which may be an evaluation to determine a confidence score, in one embodiment, the AI system may process the response incrementally as it generated, evaluating each segment substantially contemporaneously with its generation. In another embodiment, to save on resources, rather than evaluate each segment, the AI system may process the response incrementally at particular predetermined locations of the response as its generated. For example, the AI system may indicate performing an evaluation of every 3rd segment received, or after each coherent thought, or after completion of each sentence or paragraph, or some other predetermined location in the response or as a certain percentage of the response is generated, e.g. every 5% of the response generated.

The analysis and evaluation, in the example above, may involve analyzing either each segment as it is received, or analyzing a plurality of segments based on the predetermined location of analysis, e.g., every 3^{rd} segment. Doing so the AI system may enable dynamic categorization and understanding of the response as it evolves through its progression enroute to generating a complete response. This substantially contemporaneous processing may allow for an immediate and iterative analysis of the response as it is being generated rather than waiting for its completion. Such granular, real-time segmentation and analysis may also allow for a more responsive and early understanding of the response, facilitating more accurate and contextually relevant predictions of the next segments.

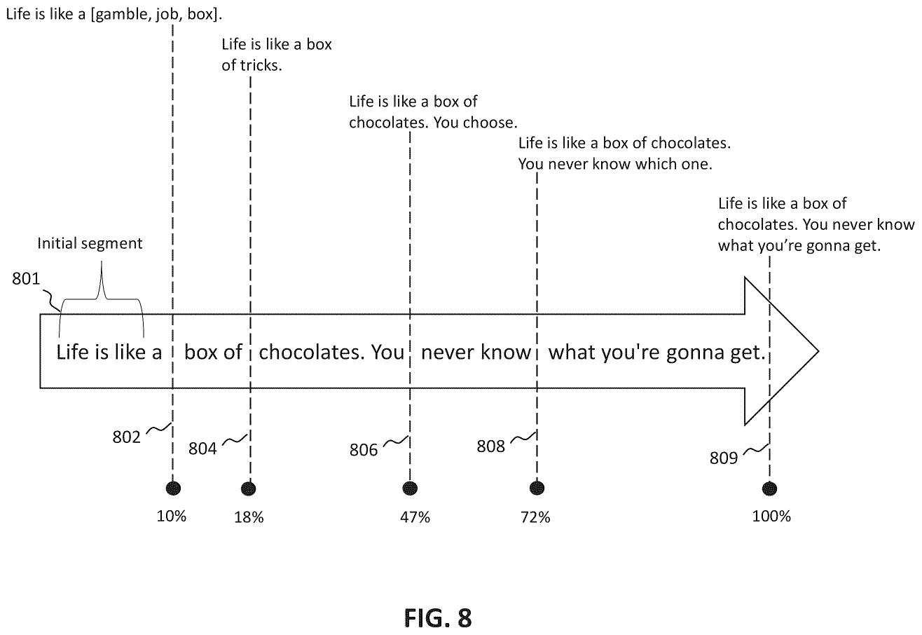

In some embodiments, the AI system may analyze initial segments of the response as they are generated and displayed. As described earlier, the AI system may define the length and type of initial segments to be analyzed. For example, the AI generative engine may indicate that the initial segment to be analyzed must contain a certain number of characters, a certain number of words, a certain length of words in a chunk, a certain number of initial words until a coherent thought or intent of the user can be determined. Although a few examples of what an initial segment may be are identified, the embodiments are not so limited and the AI system may indicate some other criteria or length of characters, words, phrases, sentences, paragraphs, pages, to be used as the initial segment for analysis. Some examples of the points or locations of analysis, the segments analyzed, the confidence scores generated for the analysis performed, and actions taken based on the confidence scores are further described in the description related to FIGS. 8-9 and 13-15.

There may be several advantages of performing such an analysis and verification at the early stages of the response as its being generated and displayed and then continuing to perform such analysis and verification at various points during the generation until the complete response is generated. For example, response accuracy may enhance resource utilization and may be minimized when such continuous, real-time verification and course correction process is performed during the response generation process. By doing so, the AI generative system, such as via its control circuitry 228 and/or 220, may minimize the risks associated with waiting until the entire response is completed or a large portion of the response if completed before evaluation, which can lead to significant cost inefficiencies and delayed error detection. Since response segments often depend on preceding ones, an early misstep can propagate errors and cause a chain reaction, leading to substantial deviations from the desired output. By identifying and correcting these errors as they occur, similar to following a wrong branch of a decision tree, the control circuitry 228 and/or 220 may prevent the accumulation of errors and avoid generating a completely flawed or hallucinated response. In some embodiments, using multiple LLM models and cascading through the models, as will be described further, may also allow the control circuitry 228 and/or 220 to cross-validate each other's outputs and minimize errors, hallucinations, inaccuracies in the response. For example, if multiple models are used, if one model produces a hallucination or error, other models may be able to potentially correct it.

At block 735, an evaluation may be made whether the performance of the one or more ELLMs in generating the portion of the response exceeds a confidence threshold. The performance of the one or more ELLMs in generating the portion of the response may be scored, to generate a confidence score, and this confidence score may be measured against the confidence threshold, which may be a predetermined score that may dynamically change based on the type of query, category of query, importance of the query.

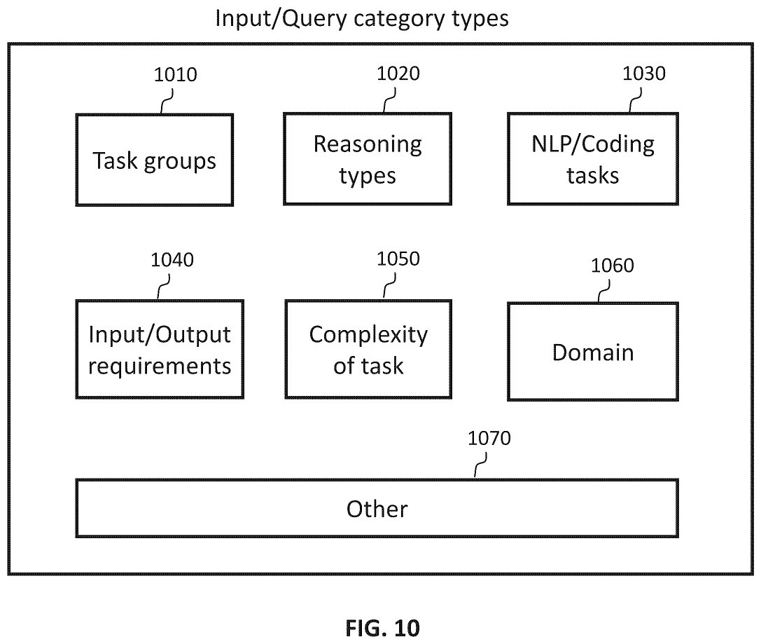

In some embodiments, the granularity of i) when and how often to measure the performance of the ELLM or LLM used for generating the response and ii) what to measure to determine the performance may be based on any one or a combination of a) the type of query as described in FIG. 10, b) system or user preferences, c) LLM recommendations, which may be recommendations from the model that generated the response, another LLM that did not generate the response, or a specific LLM that is designated in the enterprise for measuring performance, d) a domain specific LLM that has been trained with domain specific data if the query is deemed to be in that domain, and/or a judge that is designated to handle certain types of complex, advanced, critical, important, or domain specific queries.

In terms of when and how often to measure the performance of the ELLM or LLM used for generating the response, it may be based on any of the factors a)-d) or a combination thereof may be used. In some embodiments, when and how often to measure the performance may be based on the level of granularity at which the performance is to be evaluated.

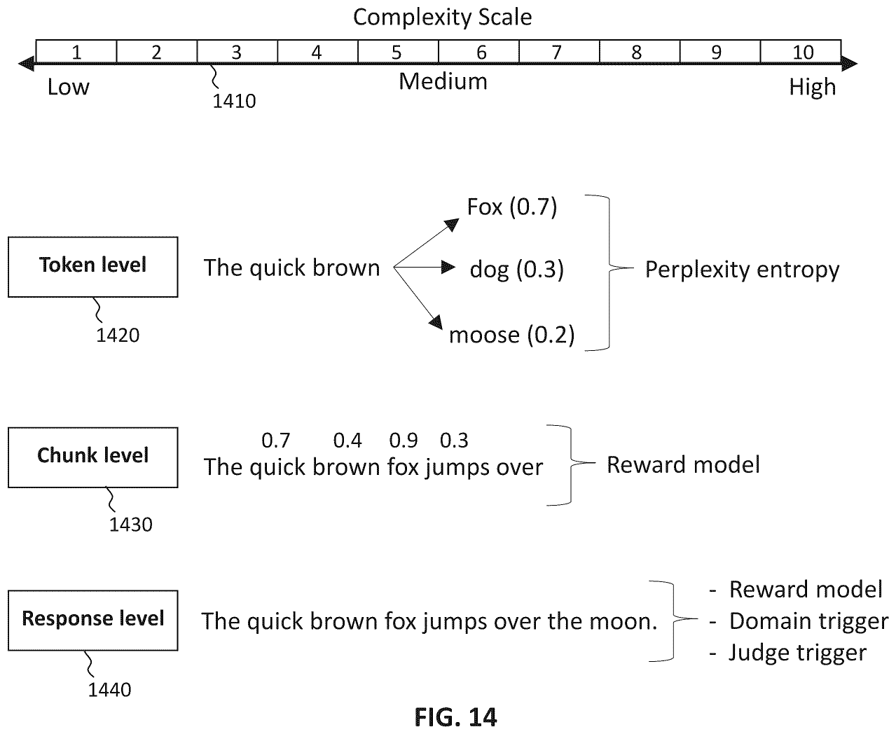

Deciding what level of granularity to use may be based on the category (also referred to as taxonomy) that was determined for the query based on analyzing the query. Some examples of the categories determined are depicted in FIG. 10. For instance, when the query was analyzed at block 715, the AI generative system, such as via the control circuitry 228 and/or 220 or via leveraging a categorizing LLM, may have determined the complexity of the query. For example, if the determination based on the analysis of the query was that the complexity of the query is low on a complexity scale, or a 3/10 on a complexity scale, such as on an exemplary scale depicted at 1410 in FIG. 14, then a higher granularity level may be selected for performance evaluation. Such a higher granularity level may relate to evaluating the performance of the ELLM or LLM on a token-by-token basis (which may mean on a word-by-word basis) or even chunk by chunk basis, e.g., a group of words at a time. When such a level of granularity is selected, then the performance may be measured to determine at each word, or every chunk of words, what predictions does the selected LLM or ELLM that generate the previous word or chunk of words, generate as the next possible word or next chunk of words.

To explain the above scenario of measuring performance at a token level, the following scenario may be used. In this scenario where token level granularity is selected based on the category of the query [or based on any of the factors a)-d)], assume that a complete response may include 100 segments, where, in this instance, since token level is selected, the segments are defined as words. The AI generative model, such as via its control circuitry 228 and/or 220 and/or by leveraging another LLM, may select token level granularity for the query, which is a high level of granularity because the query is low on a complexity scale. When the complexity is low, evaluating word by word or token on a token basis may be selected since there may be more certainty in the problem overall due to its low complexity. As such, evaluating token level granularity to make cascading decisions may be selected. In this example, further assume that the first five segments of the response may have been generated and displayed by the LLM or the ELLM. The system may then look at the next token, i.e., the fifth segment, since the fourth segment has already been generated, for evaluating the LLM or ELLM's performance. Accordingly, when the fourth segment is generated, an evaluation of the model's performance may be conducted relating to the model's ability to predict the fifth segment (e.g., words in this scenario). Since the model may predict a plurality of possibilities for the fifth segment, e.g., possibilities A. B, and C, a determination may be made whether such predictions of plurality of possibilities A, B, and C coherently, logically, contextually, grammatically, align with the fourth segment already generated. Accordingly, an evaluation may be made, based on the plurality of predictions for the fifth segment generated, whether the LLM or ELLM model's prediction ability in generating the possibilities exceeds a confidence threshold. A confidence score may be calculated based on the evaluation to determine whether the score exceeds a confidence threshold. For example, if the response to be generated may be the following sentence: “Birds of a feather flock together.” Such a response may include 6 tokens/words as follows: Birds (1) of (2) a (3) feather (4) flock (5) together. If the first four tokens have already been generated, i.e. Birds (1) of (2) a (3) feather, then the performance may be determined based on the predictive possibilities for the fifth token/word generated by the LLM or ELLM that generated the previous token, i.e., token 5, which in this example is “feather.” If the LLM or ELLM generates three predictive possibilities of the fifth segment/token/word, which are flock, gather, and cry, their confidence score may be measured based on the three predictive possibilities generated.

In some embodiments, a few approaches may be taken by the AI generative system, its control circuitry 228 and/or 220, or another LLM leveraged by the AI system or control circuitry 228 and/or 220 to determine the confidence score. These approaches may include self-reporting, reward-based approach, using a separate LLM that did not generate the response to preserve any self-bias, using a reward-based approach, or in certain instances, using an LLM judge. In one instance, when a self-reporting approach is taken, the LLM or ELLM may score the predictive possibilities it generated for the fifth segment/token/word as follows: flock (0.8), gather (0.8), and cry (0.3). In this scenario, assume that the delta may be predetermined to be 0.4 as a minimum delta for there to be enough confidence that the LLM/ELLM is confident in its predictive ability. Since flock and gather have a delta of only 0.1 (0.8−0.7=0.1), which may be below a predetermined threshold delta of 0.4, a determination may be made that the LLM or ELLM does not have a clear path for the next segment, i.e. the fifth segment/word/token and is confused. As such the overall confidence score calculated for the LLM or ELLM in its predictive ability to generate the next token may be a score that does not exceed the confidence threshold.

Taking the same scenario, assume that the LLM or ELLM generates the following three predictive possibilities for the fifth segment/token/word: flock, green, and cry. In this scenario, the LLM or ELLM may self-report a token score as follows: flock (0.8), green (0.1), and cry (0.3). Assuming the delta is predetermined to be 0.4, since there is a delta of 0.7 between the words flock and green (0.8−0.1=0.7) and a delta of 0.5 between the words flock and cry (0.8−0.3=0.5), a determination may be made that the LLM or ELLM is clear on what the next segment/work/token should be at a higher confidence level. Accordingly, a higher confidence score may be calculated which exceeds the confidence threshold.

In the above example, although a token-based performance may have been selected, in some embodiments, chunk and response level confidence may also be determined in parallel to the token level confidence but a lower weight may be placed on the since token level was selected. Likewise, in the above example, although a token-based performance may have been selected, in some embodiments, the chunk level confidence may also be determined in parallel to the token level confidence, but a lower weight may be placed on the chunk level since token level was selected. Also in the above example, even though a self-reported approach was taken, other approaches may also have been take, e.g., reward-based approach, using a separate LLM that did not generated the response to preserve any self-bias, using a reward-based approach, or in certain instances, using an LLM judge, to determine the confidence score and then determine whether the confidence score exceeds the predetermined confidence threshold.

Referring back to the level of granularity to use, as described earlier, it may be based on the category of the query determined when the query was analyzed at block 715, examples of which may be depicted in FIG. 10. In another example, if the determination based on the analysis of the query was that the complexity of the query is high on a complexity scale, or a 8/10 on a complexity scale, such as on an exemplary scale depicted at 1410 in FIG. 14, then a lower granularity level may be selected for performance evaluation. Such lower granularity level may relate to evaluating the performance of the ELLM or LLM not as often but after longer periods, such as after one or more chunks, one or more sentences, one or more groups of sentences or paragraphs, etc. When such a level of granularity is selected, then the performance may be measured to determine the predictions generated for the next words, chunks or words, one or more sentences by the LLM/ELLM after the longer periods, i.e., after a longer portion of response has been generated. For example, the evaluation location may be every 50^{th} word, or every 20 chunks of words, and not after every token. As such the segment may be defined as a certain number of words or chunks of words.

To determine the granularity and the points at which to perform the evaluation may be based on determining the inherent characteristics of the query, including its domain, complexity, input and output formats, and the desired content type, such as code or long-form documents. This type of query analysis, which may be performed at block 715, may be used to determine the most appropriate or important confidence heuristics for the task at hand. For instance, in complex tasks where lengthy outputs are expected, evaluating responses on a word-by-word basis is inefficient, premature, and incorrect. Such premature evaluations may lead to misinterpretations, as critical or more relevant parts of the longer or complex response may appear later in the generated response, such as a few chunks of words, sentences, or paragraphs later. In such scenarios, relying solely on token-based confidence may be inadequate, as the initial stages often involve preliminary reasoning and exploration, which can appear confusing until a coherent portion of the response begins to form. For instance, when a query that provides step-by-step instructions to perform a task, such as a query that guides step by step to solve this mathematical problem, the language model may explore multiple solution paths, generating seemingly disparate segments before arriving at the correct and full response. If the evaluation was done before any multiple solution paths, such as based on some initial tokens where multiple solution paths are not even established yet, such evaluation may yield results that may not be relied upon in determining the LLM or ELLM's confidence. Therefore, for complex queries, the AI generative model may wait for larger chunks of text, ranging from sentences to paragraphs, to then perform the evaluation. This can also be the case when the query is a multi-part query of a query that involves performing external functions, such as making API calls.

As such, the more complex, sophisticated, intricate, multi-staged query, the longer the wait may be before evaluating the predictive capabilities of the LLM or ELLM for generating the next segment. In such scenarios where the query is complex, sophisticated, intricate, multi-staged query, or has instructions, evaluating too early or granularly in long, sophisticated responses may obscure the overall direction and accuracy of the response. As such AI generative system may wait for the response to develop to a certain degree and be sufficient to a point where meaningful evaluation can occur, such as after as a few chunks of words, sentences, or paragraphs later. The wait period may correlate directly with the complexity of the query and other query categories from FIG. 10 and/or factors a)-d) above, and in other embodiments, the correlation may be based on a formula.

In the scenario described above, i.e., where the query is complex, sophisticated, intricate, multi-staged query, or has instructions, and a decision is made to perform evaluations on a chunk-by-chunk, or at a response level, in some embodiments, the AI generative engine may still simultaneously execute token and chunk level evaluations in parallel with response level evaluations. However, the AI generative engine may place higher weight on the evaluation performed at either the chunk level or the response level. In other embodiments, the AI generative engine may only perform evaluations at chunk or response level for such response and not perform token level evaluations.

In the scenario described above, i.e., where the query is complex, sophisticated, intricate, multi-staged query, or has instructions, and a decision is made to perform, the segment may be a chunk of words, sentences, paragraphs, or pages. Since a more complex response may be generated, the evaluation may be performed to determine whether the next portion of the text, which may be the response level, i.e. the entire response, a complete sub-response to one sub-part of the query, or a larger chunk of the text, as predicted by the LLM or ELLM is of a higher confidence. In other words, the system may look to evaluate prediction of larger portions of text rather than the next token/word. Alternatively, both LLM/ELLM's prediction ability to generate on a token level and larger portion of text may be evaluated.

Referring again to the scenario described above, i.e., when the query is complex, sophisticated, intricate, multi-staged query, or has instructions, and a decision is made to perform evaluations on a chunk-by-chunk, or at a response level, in some embodiments, the AI generative engine may use any one or more of a few approaches to determine the confidence score. These approaches may include self-reporting, reward-based approach, using a separate LLM that did not generate the response to preserve any self-bias, using a reward-based approach, or in certain instances, using an LLM judge. In another embodiment, since a determination may be made perform evaluations on a repone level, or even chunk level, the AI generative engine may automatically select an LLM judge to perform the evaluation.

In some embodiments, as referred to herein, a judge may be an LLM or an ELLM that may be a specialized, independent language model, or a plurality of language models, that are trained to evaluate the responses generated by other ELLMs LLMs. The judge may also be internal to an enterprise and may be trained with the enterprise's policies, procedures, and rubric for evaluating the performance of the other LLM and ELLMs used for generating the portion of the response. The judge may also be able to evaluate the predicting abilities of the other LLMs or ELLMs, the predictive options for next segments generated by the LLMs or ELLMs, and other performance metrics of the LLMs or ELLMs relating to the generation of the portion of the response. The judge may use a degree of precision and explainability that surpasses the evaluations performed by self-evaluation and reward techniques. For example, a reward-based approach may generate numerical scores while the judge may provide a detailed, rubric-based evaluation and explanation for the LLM or ELLM's performance. The judge may also generate comprehensive explanations and confidence scores for its evaluations of the LLMs or ELLM's performance relating to the predictive response options generated. In doing so, the judge may outline the reasoning behind its confidence score and identify specific attributes of the response that contributed to the generated confidence score. This judge may also provide insights into why a particular portion of the response, one or more predictions generated by the LLMs or ELLM's for the next word or segment are strong or weak. The confidence scores generated by the judge may then be compared to a confidence threshold to determine whether the LLMs or ELLM's performance exceeds the confidence threshold, If it does exceed then the LLMs or ELLM's may be used to continue to generate next portion of the response and if it does not then the AI generative system may cascade from the current LLMs or ELLM's to another LLMs or ELLM's for generating the next portion. As such, the judge's scoring, reasoning, and insights may be used for making cascading and switching decisions.

Although the judge's evaluation may be very useful, since utilizing the judge evaluation may incur computational cost and resource intensity associated with deploying a separate LLM or ELLM for evaluation, the judge may not be used at all times. Instead, judge's utilization may be strategically reserved for scenarios where simpler evaluation methods prove insufficient or for when the queries and accordingly the response to the query is complex, sophisticated, intricate, multi-staged, etc. The judge may also be triggered when the response to the query involves complex processes and functions, ambiguous results from initial evaluations, or a need for deeper analysis. For instance, when traditional evaluation methods, such as token based evaluation fail to provide clear direction or reveal inconsistencies, the LLM judge may be triggered to perform a more thorough assessment. The judge, in some embodiments, may use task-specific rubric that may be determined based on the category of the query, such as based on categories described in FIG. 10. Such rubric may be dynamic and constantly updated as the AI generative system continues to handle several queries. This dynamic and real-time updated rubric-driven evaluation may be used with a higher confidence for the complex, sophisticated, intricate, domain specific, or multi-staged to make cascading decisions.

Referring to what to measure to determine the performance may be based on any one category of the query and the granularity level determined for evaluating the model. For example, if the granularity determined is at token level, then the prediction of the next token may be measured to determine the model's performance. Likewise, if the granularity level is chunk or response level, then the prediction of the next chunk or response may be measured to determine the model's performance

Referring to block 735, once a confidence score is determined for the LLM or ELLM that generated the next segment, a determination may be made whether the confidence score exceeds the confidence threshold.

In some embodiments, the confidence threshold for response evaluation may be dynamically adjusted by the AI generative system, or by the control circuitry 228 and/or 220 used. The dynamic and real-time change to the confidence threshold may be based on the query's category, such as the categories described in FIG. 10. For instance, queries deemed of higher level of importance to an enterprise, such as to its core functions, reputation, or for a requested by a higher level of user, such as the CEO, C-suite employees, directors, then, for such queries, the confidence threshold may be a higher confidence threshold, to minimize even minor errors due to the query's importance and relevance. On the other hand, the confidence threshold for simpler queries with a greater tolerance for error may be set at a lower confidence threshold. The confidence threshold may be defined by the user, the company, or an LLM on a query-by-query basis, providing flexibility and customization. As described earlier, the confidence threshold may be dynamic and not static and may be adjusted by the Ai system mid-stream if the AI system determines that the response complexity exceeds initial expectations. For example, as the query is processed and the AI system integrates results from multiple language models, it may recognize the need for a higher confidence threshold than originally planned, and accordingly, in real-time dynamically adjust the confidence threshold.

If a determination is made at block 735 that the confidence score does not exceed the confidence threshold, then the AI generative system may select another distinct LLM for generating the next portion of the response. Such cascading to the next LLM or ELLM, or a set of next LLMs or ELLMs, may be based on the AI generative system determining that the current LLM, ELLM, or set of LLMs and Ellms did not perform at a high confidence level in generating the next portion. As such, the AI generative system may determine that a course correction is to be implemented by cascading to select a different LLM, ELLM, or a set of LLMs and ELLMs, based on a plurality of selection factors and then reevaluating the next selected LLM, ELLM, or a set of LLMs and ELLMs, with the same loop of blocks 725-735 to determine if the selected LLM, ELLM, or a set of LLMs and ELLMs, perform at a higher confidence and that their score exceeds the confidence threshold. In some embodiments, the AI generative system may iteratively run through a plurality of LLM, ELLM, or a set of LLMs and ELLMs, selection and evaluation until an LLM, ELLM, or a set of LLMs and ELLMs, whose response and predicting ability exceeds the confidence threshold is identified. Once identified, the process may move to block 745 where the selected LLM, ELLM, or a set of LLMs and ELLMs, are used for generating the next portion of the response.

If a determination is made at block 735 that the confidence score exceeds the confidence threshold, then the AI generative system may continue with the LLM, ELLM, or a set of LLMs and ELLMs, that generated the predictions for the next segment and confirmed the generated segment as the next segment in the response. For example, in the example above, if the next segment is a word (which may be chunk or larger portion of a response for complex queries), and the confidence level for the LLM, ELLM, or a set of LLMs and ELLMs that predicted the next word “flock” exceeded the confidence threshold, then the AI generative system me input and display the next word, flock and show the response to its current progression level which may be “Birds of a feather flock . . . .”

At block 750, the AI generative system, such as via its control circuitry 228 and/or 220, may blend responses from multiple ELLMs or LLMs by selectively combining portions to create a coherent response, as depicted at block 1650 of FIG. 16. For example, when addressing finance and sales aspects, the control circuitry 228 and/or 220 may integrate finance-related segments from a finance-trained ELLM with sales-related segments from a sales-trained ELLM. To do so, the control circuitry 228 and/or 220 may modify the segments of the response to ensure grammatical, logical, and coherent flow is maintained. Blending may also include concatenation of responses and then performing grammatical adjustments, predetermined rule application, or linguistic manipulation. Alternatively, it can involve summarizing multiple answers into a single, cohesive response.

At block 755, the AI generative system, such as via its control circuitry 228 and/or 220, may forward the blended answer to an ensemble model, which may be rule-based, neural network-based, transformer-based, or a hybrid model, as depicted at block 1660 of FIG. 16. This ensemble model may be used to process K times N number of input parameters, which are numerical values determining the language model's behavior and adjusted during training to enhance next-segments, such as next-word, predictions. These parameters, including architecture, training data, and model size, may be weighted to reflect connection strengths between neurons. The ensemble model may continuously be updated based on its learning from these parameters, refining its predictive capabilities and improving its ability to select the optimal response, e.g., the next segment, which may be next character, word, phrase, chunks, sentences, paragraphs, pages, large portions of the response or the entire response.

At block 760, the AI generative system, such as via its control circuitry 228 and/or 220, may generate a golden response to the user, obtained through iterative processing by a sequence of ELLMs and/or LLMs. This process may involve a predetermined number of iterations, dynamic determination of iterations, or feedback-driven refinement until the AI generative system, such as via its control circuitry 228 and/or 220, determines with a high confidence, e.g., confidence scoring above the confidence threshold, that the response or portion of the response, which may be next character, word, phrase, chunks, sentences, paragraphs, pages, large portions of the response or the entire response, depending on which segment is evaluated for the category of the query, exceeds the confidence threshold. In some embodiments, the AI generative system, such as via its control circuitry 228 and/or 220, may use various strategies for selecting and sequencing these language models, including repetition, revision, looping model, for example, as described and depicted at least through FIGS. 16, and 21-25 for generating the golden response to the user. Once finalized, the golden answer may be presented to the user, potentially in a customized format based on user preferences and personal information, which may be derived from user profiles or machine learning analysis of past interactions with the user. When the golden response is the next segment, or the word, such as the next word “flock” in the example above, then the AI generative system may input and display the next word, flock and show the response to its current progression level which may be “Birds of a feather flock . . . .”

At block 765, a determination may be made whether there are subsequent portions to be generated to complete the response. For example, the process may have thus far been applied to only a portion of a complete response and further response is yet to be generated. If that is the case, then the next portion of the response may be generated at block 775 and again evaluated from blocks 730 onwards until a golden response for the next portion is generated and then attached in progression of the final response. If a determination is made that there are no subsequent portions to be generated and the response is completed, then the process may move to block 770 where the final response may be output to the user on their user interface.

The process described in 700 may involve the AI generative system, which may leverage its control circuitry and/or a separate LLM to assist it, and perform the function of receiving, in real-time, the query that is to be answered using one or more language models. The process may categorize the query based on one or more categorization factors depicted in FIG. 10. The AI generative system may then select an initial language model based on the categorization of the query. The initial language model may be a single model or a plurality of models. The AI generative system may apply the embodiments described in FIGS. 16-28 in selecting the initial language model or set of initial language models. The selected language model may then generate a portion of a response to the query. This may be only a portion of the complete response that is yet to be generated. This portion of the response may include a first segment and a plurality of predictive second segments. Referring to the example above, when the response to be generated may be the following sentence: “Birds of a feather flock together,” and first four tokens have already been generated, the first segment may be the fourth word and the predictive second segments may relate to predictive possibilities for the fifth token/word. In other embodiments, the next segment may be a phrase, chunk of words, sentences, paragraphs, pages, large portions of the response, etc., one of which may be selected as a second segment that sequentially follows the first segment. The AI generative system may determine a confidence score for the initial language model that reflects the initial language model's performance in predicting the plurality of predictive second segments. The AI generative system may determine whether the confidence score exceeds a confidence threshold. Based on the confidence threshold determination, the AI generative system may determine whether to switch from the initial language model to a second language model or continue with the first language model for selecting the second segment based on the determined confidence score. The AI generative system may repeat the process throughout the course of generation of the response at various locations in the response and for various models until the response is completed.

FIG. 8 is a block diagram of an example of response and predictive response options provided at different locations in the response by the language models used, in accordance with some embodiments of the disclosure.

In some embodiments, when generating a response, such as “life is like a box of chocolate. You never know what you're gonna get” the AI generative system, such as via its control circuitry, or via an LLM used, may select an initial language model based on the determined category for query, which may have been analyzed when the query is received. As the response unfolds, word by word or chunk by chunk, a series of verification points may strategically be placed to assess if the generated portion of the response meets a predefined confidence threshold, or a changing dynamic threshold. The location of the verification points may be determined based on the level of granularity determined. The level of granularity may be based on the category (also referred to as taxonomy) that was determined for the query based on analyzing the query. For example, for a simple query, the AI system may select token level granularity, which is a high level of granularity and relates to performing the evaluations on a word by word or token by token basis. This may be because the query is low on a complexity scale. In another example, if the query is complex, sophisticated, intricate, domain specific, or muti-staged, then the AI system may select a lower granularity level for performance evaluation. Such lower granularity level may relate to evaluating the performance of the ELLM or LLM not as often but after longer periods, such as after one or more chunks, on or more sentences, one or more groups of sentences or paragraphs, etc. In some embodiments, once a query has been categorized and locations of the verification points have been determined, a language model may be selected based on the categorization to generate the response. After producing a portion of the response 801, e.g., “life is like a,” the language model may predict subsequent toke/word. These predictions may be a plurality of predictions, such as the words “gamble,” “job,” or “box.” The language model may then self-evaluate their own predictions and provide a score for each prediction, such as gamble (0.3), job (0.2), and box (0.9). The Ai generative model may also predetermine the minimum delta for the predictive capability of the LLM or ELLM used to be above the confidence threshold, such as a 0.3. If the score difference between “box” and the other options exceeds a set delta of 0.3, the model's confidence score may be high and determined to exceed the confidence threshold. The higher the delta, the higher the confidence score may be for the LLM/ELLM. In this example since the delta between box and gamble is 0.3, (09−0.3=0.6>0.3), which is greater than the delta threshold, and the delta between box and job is 0.7, which is above the delta 0.3, a determination may be made that the predicting ability of the initial language model, evaluated at this stage of the response, exceeds the confidence threshold. As such, the initial model may continue to be used to generate the next token.

The evaluation may continue at predetermined points, such as at 804, which represents 18% of the response, 806, which represents 45% of the response, 808, which represents 72% of the response, and 809, which represents 100% of the response.

Referring to an initial evaluation, which may be done at 802, which represents 10% of the response, the model's predicting ability may be determined to exceed the confidence level as described above. As such, the same model may be used to generate the next token and then again evaluated at 804. At 804, the model may have predicted the next token to be “tricks” instead of “chocolates,” using the same type of analysis as performed at 802, if a determination is made that the confidence score at this stage fell below the confidence threshold, this may trigger the AI generative system to cascade to another LLM or LLM model, or set of models for generating the next segment.

As the response progresses, the context builds, typically resulting in increased accuracy. The AI system may continuously monitor the next model's performance, i.e., the model that was selected at 804 as part of the cascading function. The AI generative may test each cascaded model and cascade/switch or keep the next model based on whether its predictive performance exceeds the confidence threshold.

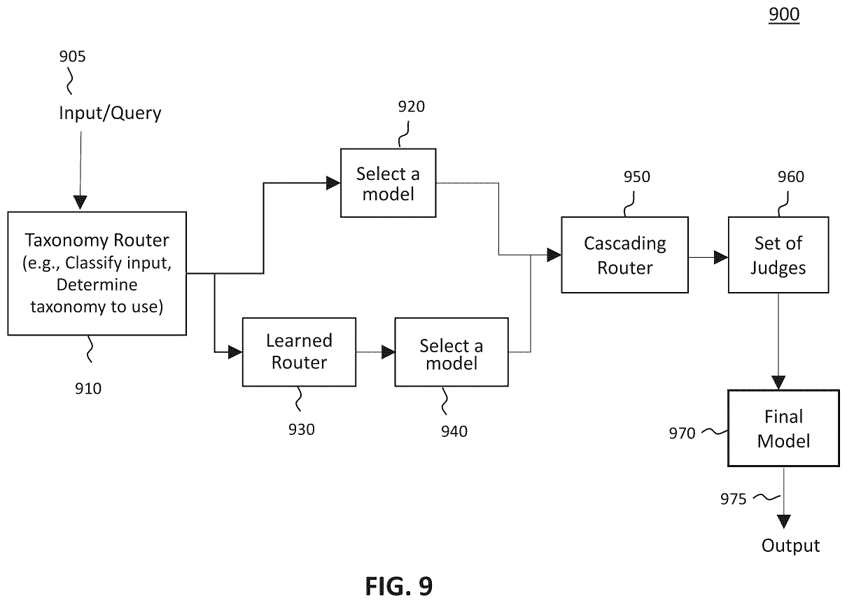

FIG. 9 is a block diagram for selecting a final language model for generating an output/response to the query, in accordance with some embodiments of the disclosure.

In some embodiments, the process 900 may involve receiving an input/query at 910. The query may be analyzed by a taxonomy router 910 (which may also be referred to as a category classification router). The taxonomy router 910, which may leverage an LLM, may determine the query's characteristics and then categorize it into one or more category classes, such as those depicted in FIG. 10. This analysis may involve using confidence heuristics and other factors, such as complexity of the query, importance, relevance to the job function of the user, etc., to then classify it into one or more categories. The taxonomy router, in some embodiments, may also determine granularity of verification to be used for evaluating the LLM model selected for responding to the query. These may include granularity options of token, chunk, or response level granularity.

In some instances, the taxonomy router may be able to directly match the input query to a suitable language model, such as the matching depicted of the model at 920. Such direct matching may be performed by the AI generative model, such as by leveraging its control circuitry or another LLM model, when the query clearly indicates a specific task for which a specialized model exists. For example, if the query requests generation of code using Python or SQL, then such a query may be matched to models trained for those programming languages. Similarly, queries seeking HR policy data may be matched by the AI generative model, such as by leveraging its control circuitry or another LLM model, with language models containing relevant departmental HR information. Such direct matching of the query to the model for generating a response may bypass the process of selecting a model by applying various selection factors

In other embodiments, there may be instances when the taxonomy router may not immediately identify a matching language model. In such instances, a learned router 930 may be used. Such learned router 930 may also be used when the query's classification yields ambiguity or requires more nuanced model selection, which leads to inability to immediately identify the most appropriate model. The learned router 930 may then evaluate a plurality of language models, utilizing methods like multi-output regression and other methods, to identify a model that may be suitable to respond to the query. By using this dual-phase strategy which uses both taxonomy and learned routing, the AI generative model, such as by leveraging its control circuitry or another LLM model, may be able to match all types of queries with the most appropriate models for generating its response.

The learned router, as referred to herein, may be a sophisticated mechanism used when taxonomy-based routing is not able to match the query with a model with a high certainty, or a certainty above a threshold level. Based on its sophistication, the learned router may be able to map complex queries with the most suitable model or subset of models and also be able to achieve an optimal balance between accuracy and cost when selecting a model. The learned router may also be performance based. It may be able to predict the performance of each of the candidate models for the query/task before selecting a model. It may make such predictions based on various factors and testing of the candidate models. For example, it may test their predicting abilities by providing sample tasks or may do so based on historical performances by such candidate models. The learned model based on the analysis and factors, may then select a model, such as model 940 for generating a response.

In some embodiments, a cascading router 950 may be used. In some embodiments, the cascading router 950 may cascade from one language model to another language model, i.e., switch from one model to another, if the currently being used language model's performance in predicting the next segment falls below the confidence threshold. To determine whether the current language model's predicting ability falls below the confidence threshold, the cascading router 950 may look for any one or more of these confidence signals: logit-based confidence, self-reported confidence, scores from reward-based approach, domain-specific verification scores, and LLM judge evaluations. These signals may each vary in reliability across different query domains. These signals may be combined by the cascading router 950 using domain-specific static weighting vectors to make a final confidence determination. When the query is domain specific, the process may include cascading router 950 classifying the query's domain using a trained binary classifier and applying domain-specific verification. The cascading router 950 may also check for logit-based confidence and if it is not available, then use self-reported confidence. As described earlier, the judge 960 may be used for certain types of queries, such as those that are complex, or those with higher level of importance to an enterprise, such as to its core functions, reputation, or for queries requested by a higher level of user, such as the CEO, C-suite employees, directors, then, for such queries, a judge may be used. The judge may also be used when other verification techniques provide ambiguous results.

The AI system may make cascading decisions throughout the response generation process, continuously evaluating model performance. This dynamic cascading process may ensure that the AI generative system uses the most appropriate models during the various stages of the response generation and performs error and course correction by cascading to different models rather than having to wait till the completion of the response.

Based on the verification process, e.g., if a judge or set of judges 960, are used, the final model 970 may be selected for generating the next portion of the response. The cascading process may repeat for each next portion of the generation for the response, where models may be switched if their predictive performance falls below the threshold, until the end of the response/output 975.

FIG. 10 is a block diagram for exemplary categories that may be associated with the query, in accordance with some embodiments of the disclosure. These categories may include task group 1010, reasoning types 1020, NLP/coding tasks 1030, input/output requirements 1040, complexity of task 1050, domain 1060, and other categories. These categories may contain further subcategories. The AI generative system may analyze the query using a plurality of factors, such as determining the content, context, and any other discernible factors from the query to then identify a category for the query. The AI generative system may then determine if a category from the category types matches the category of the query and if there is no match, then the AI generative system may create a new category. The categories include: task group (instruction following, knowledge reasoning, quantitative reasoning), reasoning type (deductive, multi-hop, domain-specific), NLP/coding requirements (transformations, generations, code manipulation), input/output formats (text, JSON, short-text, markdown), complexity level (low, moderate, high), and domain specialization (healthcare, legal, retail). These categories, and any new categories, generated by the generative AI system may be used to select a language model that fits the category, is trained with data relevant to the category, and is able to provide a response to queries in that category.

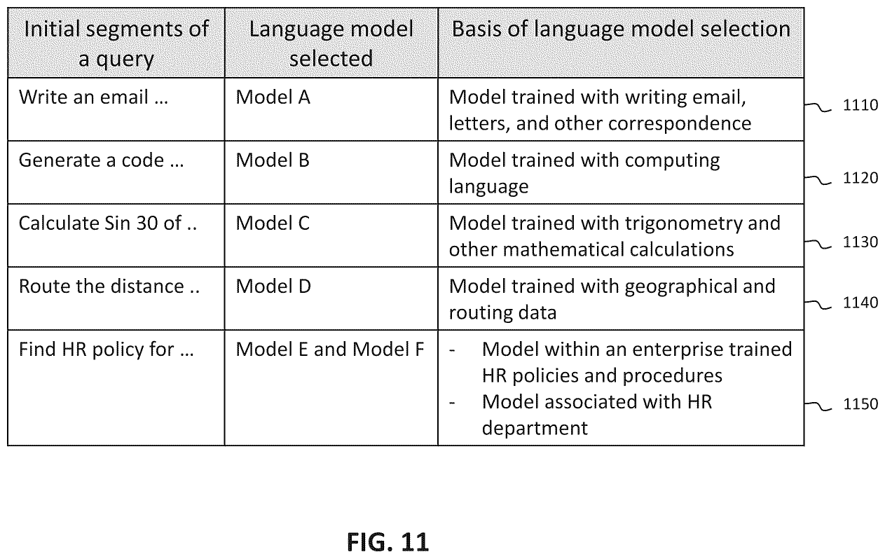

FIG. 11 is a table depicting selection of an initial language model based on categorization of the category of the query received, in accordance with some embodiments of the disclosure.

In some embodiments, the query may be analyzed once the entire query is completed to then determine a category for the query and match it with an appropriate language model. This matched model may be a model that is in the same category as the query, e.g., may be trained with data from the same category. In another embodiment, the AI system may analyze the query in real-time as it's being entered, categorizing it, and determining a matching model. The system may refine its model matching selections as the query progresses. Keyword detection from the query may also be used to determine the category of the query and then match it with the model. For example, as depicted at 1110, if the AI generative system received a query that includes the keyword “email”, then the AI generative system may select Model A, which is trained for email correspondence.

Likewise, if the AI generative system receives a query that includes “code” at 1120 or it determines based on the completion of the query that it requires code generation, then the AI generative system may select Model B that may be trained in computing languages.

As depicted at 1130, if the AI generative system received a query that includes “sin 30” or it determines based on the completion of the query that it requires a trigonometric operation, then AI generative system my select Model C that may be trained in trigonometry. Likewise, if the query at 1140 asks for the distance between points A and B, Model D, a model trained with geographical and routing data may be selected.

In some embodiments, multiple models may be selected for a query. In cases where multiple models are relevant, such as a query regarding HR policy, at 1150, the AI system may select both Models E and F, each trained on different aspects of HR data, to run them simultaneously and provide a response, such as to different aspects of the query.

Although keywords are used in the examples above to identify the category of the query, the embodiments are not so limited, and query analysis may extend beyond simple keyword matching using heuristics as described above.

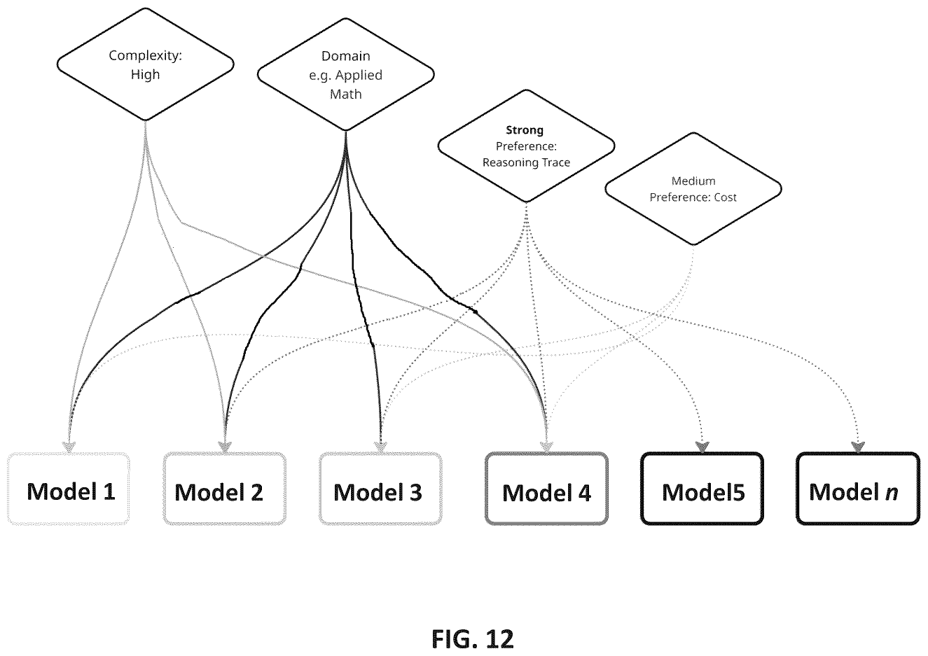

FIG. 12 is a diagram depicting the selection of a language model based on categorization of the query received, in accordance with some embodiments of the disclosure. In some embodiments, the selection of a language model to respond to a query may be based on a category of the query, which may be determined based on an analysis performed on the query when the query is received. This analysis may involve several factors, such as the query's complexity, domain specificity, reasoning requirements, content and context of the query, persona of the user asking the query, job function of the user, and user preferences regarding cost versus performance. For example, if the query is deemed highly complex, the system may identify a subset of models, such as Models 1, 2, and 4, which may be determined to be suited to handling complex tasks.

In another embodiment, domain relevance may be a factor used to select a model for rending to the query. If the query falls within a specific domain, such as mathematics, the system will prioritize models that have been trained on relevant data. In this scenario, Models 1, 2, 3,and 4 might be considered, as they may possess the necessary mathematical expertise.

In some embodiments, a single model may be identified and in other embodiments, a plurality of models, and model looping and feedback strategies, such as those depicted in FIGS. 21, 23-25 may be used.

In some embodiments, user preferences regarding cost, performance, and accuracy may be integrated into the selection of the models. If the query demands a certain level of reasoning complexity, such as medium or strong, and the user has specified a preference for either cost-effectiveness or high performance, the AI system may weigh these factors accordingly in selection of the models. The AI system may then select models that align with the weights. This type of selection process may involve assigning different weights to the query's attributes and then matching those weights to models with similar performance characteristics and may not necessarily be a direct attribute to attribute match but with some level of similarity.

FIG. 13 is a block diagram of determining confidence scores at particular locations of the response and making cascading decisions based on the confidence scores, in accordance with some embodiments of the disclosure.

In some embodiments, at 1310, model 1 may be selected to generate a response based on the query's categorization. This selection may be based on a plurality of factors including the model being trained with data that relates to the same category for which the query was categorized. As described earlier, the query may be analyzed based on a plurality of heuristics to determine which categories the query can be classified under, such as some of the exemplary categories in FIG. 10. In addition to determining one or more categories of the query, the AI system may also determine the granularity of evaluation for the response of the query. This granularity may be used to determine whether the evaluation of the model used for generating the response should be performed on a token-by-token, chunk-by-chunk, or response-level. It may also be after a certain percentage of the response is completed or after a coherent portion of the response is completed.

In some embodiments, at 1320, e.g., 16% of the response is generated and displayed, model's predictive ability may be evaluated. The evaluation point at 16%, which is just an example, may be based on the level of granularity determined. In some embodiments, at this point in the timeline of the generation of the response, model 1 may predict the next segment, e.g., the token, to be any of the following three predictions: fox, dog, and moose. In this example, the full response, which has not been completed yet at this stage, may be “The quick brown fox jumps over the moon.”

Model 1 may also self-score the predictions made as follows: “fox” (0.7), “dog” (0.65), and “moose” (0.2). Given a predetermined delta threshold of 0.3, since the delta between “fox” and “dog” is less than 0.1, i.e., less than the predetermined delta of 0.3, model 1, at this stage of the response may have confidence score that is below the threshold confidence score, which may be an indicator that model 1 is confused what the next token should be and does have a clear path between fox and dog. Accordingly, the AI system may identify model 2 based on heuristics and cascade from model 1 to model 2 at this stage. Model 2 may also be evaluated at this same stage of the response and since model 2′s predictions have a wider delta and it has a clearer preference for the next segment, which is the word “fox,” i.e. above a 0.3, it may be selected to continue with the next segment of the response.

At 1330, the evaluation of model 2 may continue at the next evaluation point, which may be based on the granularity determined during the analysis of the query. Although a level of granularity may be determined at the time of the analysis of the query, it may be modified and dynamically adjusted based on how the response is being perceived. For example, in some embodiments, the AI generative system may increase or decrease the level of granularity based on reviewing the portion of the response already generated. At this point of evaluation, i.e. when 33% of the response is completed, model 2's predictions for the next segment may include—“jumps,” “walks,” and “crawls.” Since the delta between jumps, walks, and crawls is greater than 0.3, and model 2 has a clear indication of the next token, which is jumps, a determination maybe made that model 2′s predicting ability exceeds the confidence threshold and as such model 2 should be continued to be used for generating the next segment of the response.

As model 2 is continued to be used, it may again be evaluated at the next evaluation point which may be at 74% of completion of the response. At this stage, at 1340, since the delta between words “over” and “under” and “bedsides” is less than 0.3, it may be determined that model 2 is no longer a good model to use to generate the rest of the response since its confidence score is now fallen below the confidence threshold. As such, the AI system may cascade from model 2 to model 3 which may also be tested at this same stage to determine if its predicting ability exceeds the confidence threshold period since model 3 has a clear preference for the word “over” as indicated by the wider delta with the other words under and besides (e.g., 0.8−0.2=0.6), model 3 May be selected for generating the rest of the response.

FIG. 14 is a block diagram representing taxonomy of the query and various evaluation techniques used for each type of taxonomy, in accordance with some embodiments of the disclosure.

In some embodiments, as described earlier, the query may be analyzed to determine its category or categories as well as to determine the appropriate evaluation granularity that is to be used for evaluating a response to the query as it is being generated.

In some embodiments, among others determining other characteristics of the query, its complexity may also be determined. The level of complexity may be associated with a complexity scale, as depicted at 1410. The level of complexity may be categorized using scales such as low, medium, and high, or numerical ranges like 1 to 10 or 1 to 100 or some other quantitative measure.

Based on the categorization, complexity, and other attributes, the AI system may select the evaluation granularity, which can be token-level, chunk-level, or response-level, as depicted at 1420, 1430, and 1440, respectively. Each granularity level may utilize distinct evaluation methods. For instance, at the token level, perplexity and entropy evaluations methods may be used, with the generating model providing self-reported scores. At the chunk level, we may use reward models, process-reward models, self-reported confidence, and/or auxiliary confidence estimation models. At the chunk level we may also utilize perspectives provided by aggregate metrics over the token level metrics, e.g. computing the average or variation for perplexity/entropy across all tokens in the chunk. Finally, at the response level, reward methods, domain methods, or judge methods may be used. As described earlier, judges may be used in a reserved manner when the type of query or the response justifies the additional level of detail and resource usage.

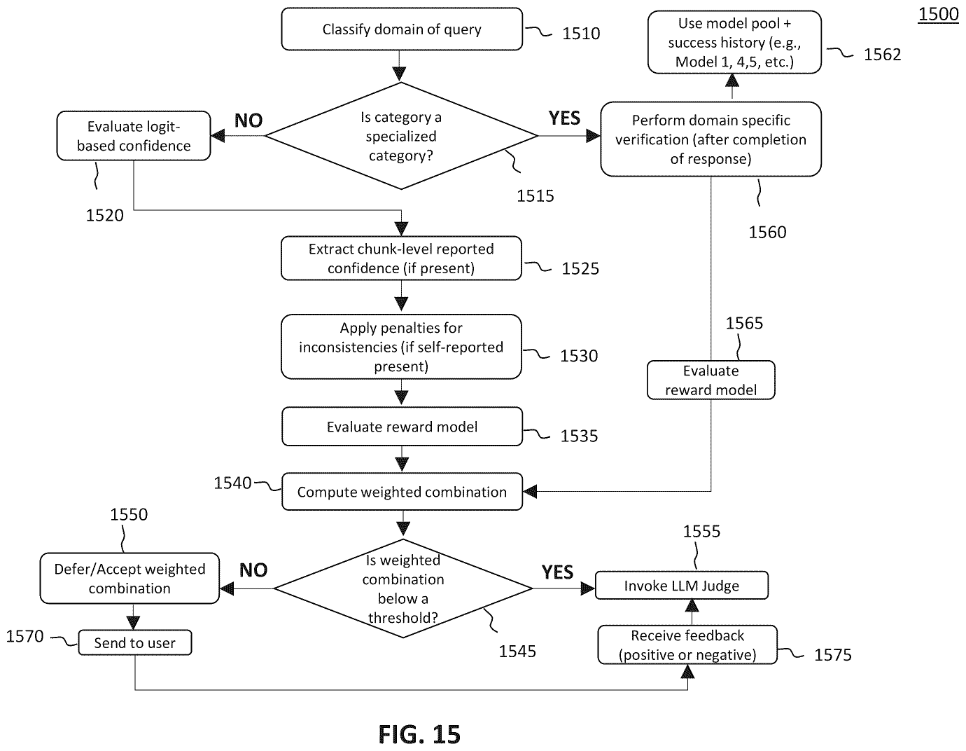

FIG. 15 is flowchart of an example of a process for performing different types of evaluations, in accordance with some embodiments of the disclosure. In some embodiments, process 1500 may be implemented, in whole or in part, by systems or devices such as those shown in FIGS. 2-3. One or more actions of process 1500 may be incorporated into or combined with one or more actions of any other process or embodiments described herein. Process 1500 may be saved to a memory or storage (e.g., any one of those depicted in FIGS. 2-3) as one or more instructions or routines that may be executed by a corresponding device or system to implement process 1500.

At block 1510, in some embodiments, the domain of the query may be determined. This may be performed based on an analysis based on the query when the query is received. As described earlier, in addition to classifying the type of query, i.e., determining its one or more categories, the determined category may be used to determine the level of granularity that is to be used when evaluating and responding to that query. In other words, how often should the response be evaluated for his category of query.

At block 1515, a determination may be made if the category is a specialized category. A specialized category, within the context of query analysis, designates tasks requiring focused and precise processing due to their inherent complexity or domain-specific nature. These categories may need a level of attention beyond that of simpler queries, often involving technical data or intricate operations. For example, a query that relates to coding tasks, mathematical calculations, and operations related to specialized fields like engineering, medicine, or accounting may be categorized as a specialized category. Queries that require detailed analyses of specific genres, such as financial performance evaluations, may also be categorized as specialized categories. What is to be considered, a specialized category may be defined by the AI generative system or discerned from the query itself. In some embodiments, any query that involves a series of tasks to be performed to provide a response or require specialized knowledge may also be classified as a specialized category.

If a determination is made at block 1515 that the category is not a specialized category, then at block 1520 the AI system may evaluate logit-based confidence. If logit-based confidence exists, it may be taken into consideration, however if it does not exist, then at block 1525 the system may obtain self-reported confidence if it is present. Self-reported confidence, as described earlier, may be confidence that is reported by the same model that generated the portion of the response. In some instances, self-reported confidence may be biased since the same model is evaluating itself, and as such, it may not be used for complicated queries where self-reported confidence may not be sufficient. In some embodiments, self-reported confidence may still be obtained, however, a higher weight may be placed on another evaluation method, such as the judge evaluation method. In some embodiments, although references may be made to a single heuristic, such as logit-based, the AI generative system may simultaneously run as many heuristics as available. For example, it may run evaluations based on self-reported, reward-based, and judge-based methods. The AI generative system may then weigh the results from heuristic, such as based on category of query, where results from one heuristic may be weighed differently than another heuristic in calculating the aggregated result.

At block 1530 if self-reported confidence level is present, then penalties may be applied for any inconsistencies that are also self-reported.

At block 1535 a reward-based approach may be used for evaluating the model's performance as it relates to predicting the next segment. A reward-based approach may assign numerical scores, ranging from highly positive to highly negative, to indicate the confidence level of the prediction, such as +50 or −50. A strongly positive score may indicate high confidence, while a strongly negative score indicates low confidence in the model's predicting ability. A neutral score may indicate uncertainty in the model's predictive ability. The reward-based approach may provide numerical assessments without providing detailed reasoning behind its confidence evaluations. As such, when reading is required for complex queries, a judge may be used instead.

At block 1540, all the evaluation methods and their results may be computed and weighed together. A determination may be made at block 1545 whether the weighted combination is below a threshold. In other words, if the average of all the evaluations performed and their weighted average is below the confidence threshold.

If a determination is made that the average weighted score is above the confidence threshold at 1545, then the system may, at block 1550, either defer the weighted combination or accept the weighted combination. For example, if the weighted combination is above a threshold that it may accept the weighted combination or defer it. If a determination is made that the average weighted score is above the confidence threshold at 1545, then the AI system may provide the user with the details of the weighted combinations. In some embodiments, the details may include the weighted combination numbers and in other embodiments, the details may include additional information such as reasoning why weighted combination is determined by the AI system to be above the threshold, details of what the threshold was set to, predictions by the model that led to the reasoning, and options for use user to provide feedback as well as change the threshold criteria. The user receiving the details at block 1570 may provide positive or negative feedback at block 1575. Such feedback may be taken into consideration by the LLM judges at 1555 and used in future evaluations of the model. The LLM judges may also use the feedback to calibrate the reward method (at 1535) or the self-reported method (at 1525). The AI generative system may also use the calibrations performed to the reward method (at 1535) to further modify the self-reported method (at 1525), and the calibrations may be further used to refine the logit-based method at 1520. In brief, the user feedback may be used to refine and calibrate all logit-based, self-evaluation based, reward-based, and judge-based evaluations such that when such methods are used in the future for similarities, the calibrations are taken into consideration during evaluations. In some embodiments, a preferred method may be used to calibrate the less preferred method, e.g., if the judge or the reward-based method is preferred for a query, then the results from evaluations using the preferred method may be used to calibrate other methods, such as self-reporting, logit-based, or vice versa.

At block 1545 if the weighted combination is below a threshold, which may indicate ambiguity or confusion in the model's ability to predict the next segment, a more detailed evaluation may be needed and as such an LLM judge may be invoked the 1555.

The judge, in this context, as described earlier, may refer to a specialized language model designed to provide detailed, expert level evaluations of the response generated by the model. The judge may utilize a query-specific rubric, generated from historical data and training, to evaluate the model's predicting ability. This rubric may include evaluation parameters, parameter weights, and scoring criteria to be used for the specific query type. The judge may analyze the model's predicted options for the next segment in the response according to this rubric, producing confidence scores, an overall quality score, and a confidence estimate. This detailed analysis may allow the judge to provide a comprehensive explanation of why a model is performing well or poorly, offering insights into the model's strengths and weaknesses relating to its prediction function.

Judges may not always be used but reserved for certain situations. In one instance, they may be invoked in specific scenarios where other evaluation methods prove insufficient. In another instance, then may be invoked when the weighted combination of other confidence signals falls below a certain threshold, indicating ambiguity or uncertainty. They may also be instances when borderline scores are present, acting as an additional confidence estimation parameter, or when the query is highly complex, requiring a more sophisticated evaluation. Since the judge may be expensive due to the specialized LLM they use, they may be invoked, as described above, only when aggregate signals remain inconclusive.

In some embodiments, to enhance reliability and reduce bias, multiple judges with distinct architectures may be used. Each judge may evaluate the same model's predictions at a particular stage in the response. Each judge may also run the evaluations multiple times on the same predictions by the model and the scores across the judges and multiple iterations may be averaged to determine the confidence level. When the two judges exhibit significant disagreement, exceeding a predefined threshold, the query, response, and result may be flagged for human expert review. By doing so, the AI system may utilize the specialized knowledge of the human and refine its model based on the knowledge gained.

If a determination is made at block 1515 that the category is a specialized category, then at block 1560 the AI system may perform domain specific verification and evaluation of the language model, which may be after the completion of the response, using reward-based methods as described in 1565. The AI system may then follow steps 1540-1555 and 1570-1575. At the domain specific verification and evaluation stage, the AI generative system may, at block 1562, look to the model pool to select models that have a success history of performing above a threshold. For example, if the pool is 10 models, and models 1, 4, and 5 have a proven track record of performing above the confidence threshold, then the AI system may select from models 1, 4, and 5 based on heuristics and select one or more of them to perform the domain specific evaluation.

In some embodiments, the AI generative system may evaluate the predictive availability of its models using multiple types of evaluation methods, e.g., logit-based, self-reporting, rewards-based, and judge-based confidence evaluations and as such obtain confidence scores from each such evaluation. When multiple confidence assessments and confidence scores are determined, the AI generative system may aggregate these assessments and scores by calculating an average, mean, standard deviation, or applying another weighted formula to derive a final aggregated confidence level. The weighting of individual confidence scores may be dynamic, influenced by the nature of the user query and predefined preferences, or alternatively, all assessments may be weighted equally. For complex queries, the system may prioritize the judge-based confidence level and score due to the potential absence of a fully formulated response for token-level evaluation. For such queries, the system may also prioritize the judge-based confidence level since the judge may be the most powerful confidence estimation system as it may have been trained to align with human evaluations to provide reasoning and critiques on a variety of attributes. For example, the judge may provide reasoning, critique, and instructions to follow related to the attributes such as factual correctness, clarity/structure, relevance of information, and soundness. In some embodiments, the AI generative system may retain the flexibility to selectively utilize one or more confidence assessments and scores from the available methods. In some embodiments, a separate LLM or ELLM may be used to intelligently determine the appropriate weighting for each confidence score based on the query type and to compute the final aggregated confidence score.

As described earlier, confidence may be self-reported or determined based on other methods, such as reward-based method, judge, etc. Confidence may also be determined simultaneously at various levels of granularity, such as at for token, chunk, and/or response level. In some instances, although a preference may be indicated towards a particular type of confidence method for a particular granularity, the AI generative system may simultaneously determine confidence levels using other methods as well. For instance, the AI generative system may perform a chunk-level or response level confidence evaluation of a model but simultaneously obtain token level confidence as well. In another instance, the AI generative system may obtain both self-reported confidence, which is reported by the very model that predicted the next token, and then independently perform token-level or chunk-level confidence for the same segment for which self-reported confidence was obtained.

When multiple confidence gathering methods are used simultaneously, then there is a likelihood that the confidence level obtained through one method may not align with confidence level obtained through a different method. For example, self-reported confidence may be in a disagreement than reward or judge-based confidence obtained for the same granularity. This discrepancy can arise due to various factors. For instance, a model that generated the next token (or chunk or response) might be biased in self-reporting its own confidence. In another instance, the model may lack the training to perform a thorough analysis of its own confidence. In yet another instance, although confidence may appear plausible at a high level, which may be how the model conducts self-evaluation, which may lead to a strong overall confidence score. However, upon closer examination at the token level, it may reveal underlying uncertainty or lower predictive probability for those specific elements. Whatever the reason may be for the disparity between different methods of obtaining confidence, when such disparity occurs, the AI generative system may automatically perform calibration of the confidence level scores reported through various methods. Below are some examples to illustrate the embodiments of the AI generative system's calibration performance in various scenarios. Although a few scenarios are described, the embodiments are not so limited and other scenarios are also contemplated.

In one embodiment, self-reported confidence may be low while token level confidence may be high thereby creating the confidence scoring disparity between the two methods. This pattern may suggest that while the model had high certainty during fine-grained (token/word level decisions) but when looking at the full sentence/chunk it constructed, the overall confidence in its statements were much lower. In this scenario, the AI generative system may perform a calibration across both scores reported through different methods to then determine a final outcome, i.e., an aggregated confidence score for the model's ability to predict the next segment. Accordingly, in this scenario if both confidence scores from the self-reporting method and non-self-reporting method were to be weighted equally, i.e. such as in a linear combination, then any overall confidence calculated based on such equal weighting may not be accurate. As such, the AI generative system, in this scenario may calibrate by reducing the weight assigned to the self-reported confidence and keep the weight for confidence score obtained via non-self-reporting methods. More specifically, the AI generative system may calibrate the evaluation system to recognize that in this style of queries, a lesser reliance should be placed on self-reported confidence in the future. As such, if previously the combined score may have been: 1×(token-level confidence)+1×(self-reported conf), the newly calibrated method of evaluation may now weigh as follows: (0.5×(token-level confidence)+1×(self-reported conf). The AI generative system may calibrate the evaluation model with the above-mentioned calibration such that when similar queries are detected in the future, the evaluation is performed with the new calibration.

In another embodiment, in a different scenario, a response-level reward model, responsible for assigning confidence scores based on the quality and appropriateness of the predicted next segment by the model, may be in a disagreement with either the self-reported confidence of the model or the token-level confidence scores. In this embodiment, the disagreement may signal a potential misalignment between the model's internal assessment of its output and an external evaluation of the model's predictive ability to predict the next segment. When such confidence disparity between two methods exists, the AI generative system may perform a calibration to perform reweighting of the combined confidence score. When the reward model indicates low confidence despite high self-reported or token-level confidence (or vice versa), the AI generative system may use such data as training data to adjust the influence of these individual confidence signals for similar queries in the future. This reweighting, potentially based on a categorization or taxonomy of query types where such discrepancies are more frequent, may be performed by the AI generative system to ensure that the final confidence score more accurately reflects the external evaluation provided by the reward model.

In yet another embodiment, the AI generative system may detect a confidence level score or confidence assessment disparity between a confidence score obtained from a rewards-based approach with the confidence score obtained using a judge-based method. Such a disparity in confidence assessments and scores may trigger both short-term and long-term adjustments within the AI generative system. In one embodiment, in the short term, the AI generative system may give more weight to the confidence assessments and scores obtained from the judge than those obtained using the reward method. In some embodiment, in the long term, and upon accumulating a sufficient amount of data, which may be 500 samples, 1000 samples, or some other predetermined number, the reward models themselves may be retrained based on the sampled data by the AI generative system. Such a retraining process may be performed to increase the penalty assigned by the reward models in these failed scenarios where the confidence scores obtained via the rewards-based approach are in disagreement from the judge's confidence evaluation and confidence scores for the model. To perform such a retraining, the AI generative system may use a process of synthetic data generation here to make sure we augment the data volume for amplifying this signal to ensure that reward models align with the judge's confidence evaluations.

In some embodiments, the sentence/chunk level confidence evaluation/assessment and related confidence score, as described above, may come from an external method such as a process reward model (PRM) or any auxiliary confidence estimation model, which rewards/penalizes steps taken to reach a final response as opposed to rewarding/penalizing the final response. Such external verifications may be used to identify and flag a model's bias towards its own generations (overconfidence), where it is both confident of its response at the token-level and sentence/chunk-level.

In some embodiments, token level confidence (TLC) may be compared with self-reported chunk-level confidence (SR-CLC)-both may come from the “current” LLM, i.e. the model used to generate the predictions). TLC and SR-CLC may be compared with a PRM/chunk level model (AUX-CLC). TLC, SR-CLC, AUX-CLC can be compared with a response level [confidence] reward model (RM-RLC). Finally, TLC, SR-CLC, AUX-CLC, and RM-RLC can all be compared against the response level judge(s).

In some embodiments, a user may provide negative feedback, such as a dislike of the final answer as well as reasoning for such dislike. When such negative feedback and reasoning is obtained by the AI generative system, it may be used for tuning and calibrating the evaluation of future queries based on the feedback provided. For example, the user feedback may be used for tuning the set of final judges such that when they evaluate future responses to queries of a similar category, they take the user feedback into account. Additionally, by analyzing user dislikes and their associated feedback, the AI generative system may be able to identify. Such calibrations and tuning of the judges may involve adjusting the criteria used by existing judges, updating their training data, updating the rubric used by the judges, or even introducing new judges with different areas of expertise.

In some embodiments, where specific domain verifiers consistently fail for a particular model-for example, a model repeatedly generates buggy or non-executable SQL queries or code-the AI generative system may implement both short-term and long-term calibration techniques as described above. In the short term, the reranking process that occurs before cascading execution begins may automatically assign a lower priority to this consistently failing model in which confidence levels are lower than the confidence threshold. Over the long term, if this pattern of failure persists, the model may be completely removed and not reused again, and the AI generative system may select other LLMs or ELLMs that do not suffer from the same pattern. In other embodiments, once removed, the model may be brought back once a human expert can verify and rectify the underlying issue causing the failures.

In some embodiments, if a model repeatedly fails to generate responses due to availability or infrastructure issues, such as a network outage affecting the provider of the model (e.g., OpenAI experiencing issues impacting various of their models), the AI generative system may perform both short term and longer-term actions. In this scenario, in one embodiment, in the short term, the AI generative system may use a reranking mechanism to lower the priority of the affected model. The AI generative system may also extend this reduced priority to all models originating from the same failing provider to prevent a broader service disruption. In some embodiment, in this scenario, in the long term, if this pattern of unavailability continues, the AI generative system may completely remove the problematic model such that it is not used by the AI generative system. The model may be brought back only if a human expert resolves its underlying issues.

FIG. 16 is a block diagram of an example of selection of enterprise and public language models and their use to obtain a curated/enhanced response or portion of the response, in accordance with some embodiments.

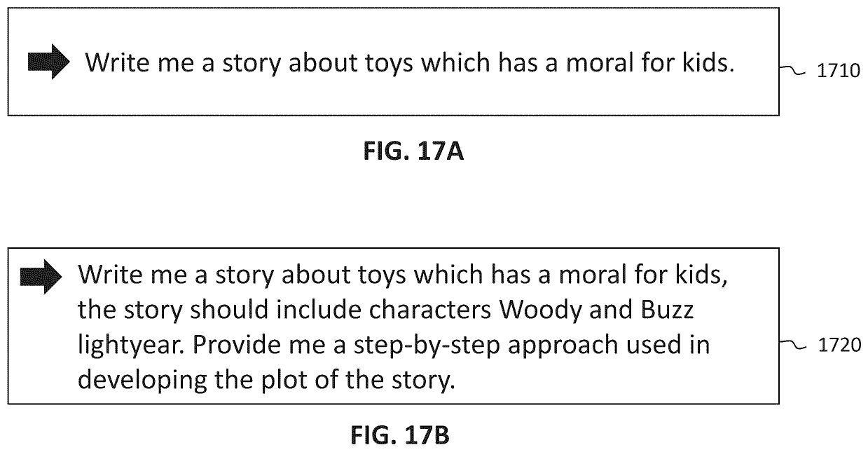

In some embodiments, block 1610 represents a query that may be presented by a user. The query/question/task may be a simple query (e.g., as depicted in FIG. 17A at 1710), which involves single requests, such as problem-solving, vacation time inquiries, contract retrieval, or code generation. It may also be multipart or complex query (e.g., as depicted at 17B at 1720) that requires responses based on multiple factors, instruct LLMs to process and synthesize information from various sources, instruct explaining the solutions, generating code with detailed rationale, projecting revenue, or creating personalized responses from multi-departmental data. Additionally, users may input queries/questions, documents, and other materials that provide specific facts for the LLM to incorporate into its response, such as a long contract or request for proposal, that may include both internal enterprise data and publicly available information.

In some embodiments, block 1620 represents filtering from k number of ELLMs to n number of ELLMs. The k number of ELLMs, as described earlier in description related to FIGS. 4-6, may be generated by extracting enterprise data, such as at blocks 410, 510, and 610 of FIGS. 4, 5, and 6 respectively. The data extracted may be classified and curated for quality and used to generate and train the k number of ELLMs. Although not shown in FIG. 16, the control circuitry may apply a similar filtering process to filer k number of LLMs to n number of LLMs. As described earlier, ELLMs as used herein refer to enterprise LLMs while LLMs, as used herein refer to publicly available, or LLMs available through a subscription or a service that are outside the enterprise setting. Some examples of the filtering process are described in the description related to FIGS. 18-22, 26A-C, and 27-28 below.

In some embodiments, once the ELLMs and LLMs have been filtered to a narrowed set of ELLMs and LLMs, blocks 1630 and 1640 represent selective usage of the narrowed set of ELLMs and LLMs by the control circuitry to obtain an response/answer to the query from block 1610. The control circuitry 228 and/or 220 may determine a strategy to select certain ELLMs and LLMs and revise the strategy as needed to obtain a response or a portion/segment of the response. The strategy may be used, as described in FIG. 7-9, 11-13 to select an initial model or to select the cascaded model, which may be LLS, ELLMs, or a combination of LLMs and ELLMs, when the original model is determined to be performing below the confidence threshold. Some non-limiting embodiments of ELLMs and LLMs selections used are described in the description related to FIGS. 20-25.

In some embodiments, the control circuitry may obtain responses or portions of the response, such as on a token by token or chunk by chunk level, from each of the ELLMs and LLMs selected as part of the strategy. All the responses obtained may be blended at block 1650 using a blending process. The blending process may selectively pick all or portions of responses from each of the ELLMs and LLMs used at blocks 1630 and 1640 to blend a response that is cohesive, grammatically correct, and logical. The control circuitry 228 and/or 220 may also modify the blended response to ensure that the response is cohesive, grammatically correct, and logical.

At block 1660, in some embodiments, the blended response may be used as an input into the ensemble model to obtain a golden response. In some embodiments, the golden response may be a portion of the response, such as the next token, chunk, or response level. In some embodiments, the control circuitry 228 and/or 220 may reformat the blended response in the form of a query that is used as an input into the ensemble model.

Also at block 1660, in other embodiments, both the blended response and the original query from block 1610 may be used as an input into the ensemble model to obtain a golden response. In some embodiments, the blended response and the original query may be fed into the ensemble model separately to obtain two golden responses to compare and contrast between the two responses obtained. The ensemble model may be a model that may be used to determine a better response for the query 1610 and the blended response, which may be reformatted as a query. As described earlier, the ensemble model may be a ruled-based model, a neural network-based model, a transformer-based model, or a combination thereof. The ensemble model may also be a combination of a plurality of selected models. The ensemble model may be used to get a better or a more enhanced and thorough response to a query.

In some embodiments, a sample or preferred response may also be inputted into the ensemble model along with the blended response and the query 1610. The sample response may be used as training data for the ensemble model to further refine the golden response.

FIG. 18 is a block diagram of an example of matching a language model to a query based on the categorization of the query, context of the query, and/or the user credentials, in accordance with some embodiments of the disclosure.

In some embodiments, an input into an ELLM selection module 1820 may be a query/question (Qi) and identity of a user (Ui), as depicted at block 1810. The ELLM selection module 1820 may analyze both the content and context of query Qi and the identity of the user Ui to select one or more ELLMs 1830. The selected ELLMs 1830 may be used for processing the query Qi for determining a response that may include data to which the User Ui is authorized to receive.

As depicted in FIG. 18, in some embodiments, queries Q1, Q2, and Q3 from users User 1, User 2, and User 3 may be received at blocks 1840, 1842, and 244 respectively. Each user, from the set of Users 1-3, may be associated with a certain category or level of authorized access in the enterprise.

In some embodiments, access to confidential enterprise data may be controlled based on user roles and permissions. For instance, associates may be provided with limited access, contractors may have none, and CEOs have full access. Similarly, departmental access may also vary. While access levels may be determined by the AI system by factors like job title and experience, the term “category of access” may be broadly to describe these varying levels of data authorization. Models may be selected accordingly based on the user asking the query, for instance, only models trained with data that is allowed access to the user may be selected.

In some embodiment, a determination may be made that User 1, who input query Q1, is allowed access to enterprise data that falls in Category 2. A determination may also be made that the query inputted by User 1, i.e., Q1, contextually relates to topic 4. As an example, this may be a topic that relates to a function in the enterprise or a department, such as finance or engineering department.

Likewise, a determination is made that User 2, who input query Q2, is allowed access to enterprise data that falls in Category 2. A determination may also be made that the query inputted by User 2, i.e., Q2, contextually related to topic 3.

Additionally, a determination may be made that User 3, who input query Q3, is allowed access to enterprise data that falls in Category 7. A determination may also be made that the query inputted by User 3, i.e., Q3, contextually relates to multiple topics, i.e., topics 2 and 8.Although users may be classified as having access to multiple types of confidential and proprietary enterprise data, including confidential and proprietary enterprise data from different departments based on their authorized access level, and the content and context of the query may relate to more than one category or genre, for sake of explanation and simplification, only certain categories of access and context types are discussed.

In some embodiments, the ELLM selection module 1820 receiving the query from the user may analyze the identity of the user, associate the user with a category of authorized access to confidential and proprietary enterprise data. To do so, the ELLM selection module 1820 may access various enterprise databases, applications, local and cloud storage devices and applications, and any other library in which enterprise data is stored and to which the ELLM selection module 1820 is authorized to access. For example, the ELLM selection module 1820 may access Salesforce's desk.com™ application, Oracle's NetSuite™ application, databases relating to marketing, engineering, facilities, management, or finance departments, data from documents, logs, policies, employee profiles, employee job titles and roles, employee performance reviews, conference call recordings, etc. The ELLM selection module 1820 may, based on the accessed databases, applications, local and cloud storage devices and applications, and any other enterprise data, may determine which category of access is authorized for the user.

In some embodiments, the ELLM selection module 1820 may analyze the content, context, and category of the query received (as described earlier at block 715 of FIG. 7). The ELLM selection module 1820 may use the results of the analysis to classify and categorize the query. For example, analyzing the content and context of the query Q1, the ELLM selection module 1820 may place Q1 in category 4. In other embodiments, the content and context of the query Q1 may have been analyzed prior to the submission of the query to the ELLM selection module, such as by process of FIG. 7.

Based on the identity of the user, the user's authorized access to enterprise data, and the content and context of the query, the ELLM selection module 1820 may select 1 or more LLMs for processing the query. In other words, the ELLM selection module 1820 may determine a match between the input (identity of user and content/context of query) and an ELLM. The ELLM that may be selected as a match by the ELLM selection module 1820 may be an ELLM that has been trained with confidential and proprietary enterprise data to which the user is authorized to access and the training data used to train the selected ELLM may be relevant to the content and context of the query.

In some embodiments, ELLM1 1860 may have been trained with confidential and proprietary enterprise data that may be associated with categories 1-5. The data used to train ELLM1 may contextually relate to context types 1, 3, and 9. Likewise, ELLM2 1862 may have been trained with confidential and proprietary enterprise data that may be associated with categories 2, 6, 9-11. The data used to train ELLM2 may contextually relate to context types 2-4and 7. Additionally, ELLM3 1864 may have been trained with confidential and proprietary enterprise data that may be associated with categories 7-10. The data used to train ELLM3 may contextually relate to context type 8. Although some categories associated with confidential and proprietary enterprise data and context and content type were described in FIG. 18, the embodiments are not so limited and any ELLM may include one or more categories associated with confidential and proprietary enterprise data and context and content type.

The ELLM selection module 1820 may match both the user access categories and the content/context categories of the query from blocks 1840, 1842, and 1844 with one or more matched ELLMs. As depicted, based on a match, since Q1 is related to context type 4, and User 1 has category 2 level of authorized access to confidential and proprietary enterprise data, the ELLM selection module 1820 may select ELLM2 to process the query from block 1840. This may be because ELLM 2 allows users with category 2 level access to its data and its training data has been classified as associated with context types 2-4, and 7.

Following the same type of analysis, the ELLM selection module 1820 may determine a match between query Q2 at block 1842 and ELLM1 and ELLM 2 and assign the query to be processed by both ELLM1 and ELLM2. The ELLM selection module 1820 may also determine a match between query Q3 at block 1844 and ELLM3 and assign the query to be processed by ELLM3. As depicted, depending on the query and the identity of the user, the ELLM selection module 1820 may select one or more ELLMs to process the query, such as Q2 being processed by ELLM1 and ELLM2. The process described in FIG. 18 may, in some embodiments, be part of the language model selection process described at blocks 730 of FIGS. 7 and 1630 of FIG. 16. It may also be to select an initial model, a cascaded model, or additional model used throughout the cascading process during the generation of the response, when the initial model, or the any of the cascaded model, perform below a threshold confidence level.

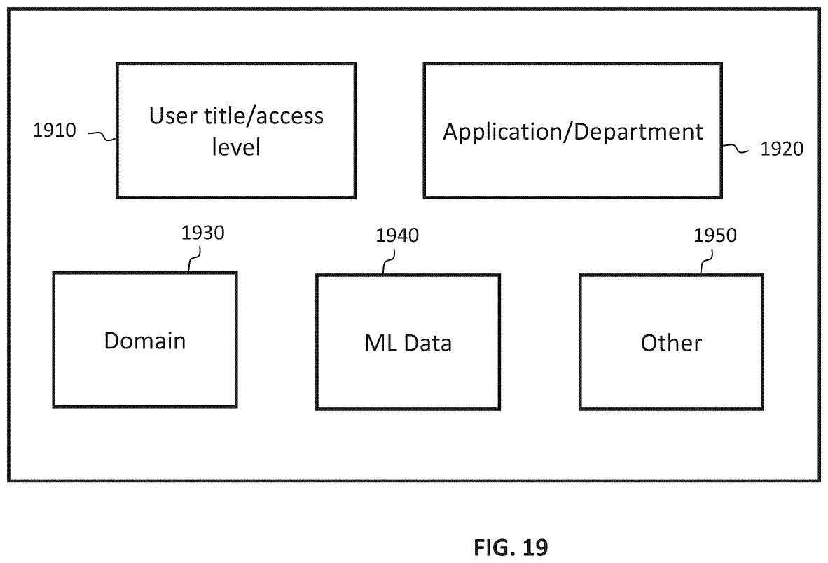

FIG. 19 is a block diagram of an example of selection criteria used for selecting an initial or cascaded language model, in accordance with some embodiments of the disclosure. The selection criterion for selecting a model based on tiers of access levels used may, in some embodiments, include selection based on user title/access level 1910, application/department 1920, domain 1930, machine learning (ML) data 1940, and other criterion 1950.

In some embodiments, user title/access level may be determined, such as by an ELLM selection module 1820 in FIG. 18. As depicted in FIG. 20, different tiers of access levels may be associated with different tiers of employees based on their job titles. In some embodiments access levels that range from access level 1 (2010), which may be associated with the lowest level of access to confidential and proprietary enterprise data, to access level 5, which may be associated with the highest level of access to confidential and proprietary enterprise data and may be reserved for employees with highest level of clearance to access authorized data, such as the CEO or C-suite employees. Although a few tiers of access levels and associated employes are depicted in FIG. 20, the embodiments are not so limited and other types of tiers and access levels are also contemplated.

In some embodiments, the AI system may utilize the ELLM selection module 1820 (FIG. 18), to determine user access levels, aligning with job titles as shown in FIG. 20. Access levels range from level 1 (2010), representing minimal access, to level 5, granting maximum access, typically reserved for high-ranking employees like CEOs. While FIG. 20 illustrates specific tiering, the system supports various access level configurations.

As depicted in FIG. 20, access level 1 (2010) may be the lowest access level to confidential and proprietary enterprise data that may be accessed by all employees 2015. Accordingly, if an ELLM has been trained with access level 1 data, such ELLM may be used to process a query from any of the employees 2015 if it includes data that is relevant to the content, context, and category of the query.

Likewise, access level 2 (2020) may be an access level that is higher than the lowest access level 2010 and it may provide access to a higher level of confidential and proprietary enterprise data that may be accessed by managers 2016. Accordingly, if an ELLM has been trained with access level 2 data, such ELLM may be used to process a query from any of the managers in 2016 but not all employees in 2015. In other words, even if the ELLM that has been trained with access level 2 data may include data that is contextually relevant to a query inputted by an employee 2015, it may not be selected by the control circuitry or the ELLM selection module, since employees 2015 do not have the higher level of authorization required to access data from such an ELLM.

In another embodiment, access level 5 (2050) may be the highest access level in the enterprise. In other words, it may include the most restrictive data that can be accessed only by the employees that have the highest level of authorization. As depicted, access level 5 may be restricted to only the CEO, CFO, and COO 2019. Accordingly, if an ELLM has been trained with access level 5 data, such an ELLM may be selected to process queries only if the queries are inputted from CEO, CFO, and COO 2019. Such an ELLM may not be selected by the control circuitry or the ELLM selection module even if it includes data that is contextually relevant to queries inputted from other employees besides the CEO, CFO, and COO 2019, such as managers 2016, directors 2017, EVPs 2018, since such employees may not be authorized to access data that is categorized as access level 5 data. The selection of language models described in FIG. 20 may be used for selecting the initial model, cascaded model, or subsequently cascaded models throughout the response generation process until its completion when earlier model's performance falls below the confidence threshold and new models are selected for cascading.

FIG. 21 is a block diagram of an example of selecting ELLMs from different departments in a company based on their contextual and categorical relationship to the input query, in accordance with some embodiments of the disclosure. In some embodiments, a query 2110 may be received by the ELLM selector 2120. The ELLM selector 2120 may analyze the content and context of the query and determine which department or topic related language model is most relevant to respond to query 2110. Since an enterprise may include a plurality of ELLMs, where each ELLM may be associated with a specific department of the enterprise, the ELLM selector may determine based on the query 2110 which department specific ELLM is most relevant to the query and select that ELLM to process the query.

In other embodiments, the ELLM selector uses both the query 2110 and the user's department (and level of access) to determine the most relevant department-specific language model to prepare a response to the query. This may be when selecting the initial model or model selected after cascading, such as in FIGS. 7-9, 11-13. In instances, for example, where an engineering employee asks an HR-related query, the HR-trained ELLM might be bypassed due to potential access restrictions for the engineering employee. However, in other instances, the HR-trained ELLM might still be used, but with data access limited to information permissible for employees outside the HR department, such as the engineering employee. This is achieved through rules configured within the ELLM, which regulate training data usage based on user authorization.

In some embodiments, as depicted in FIG. 22, a general ELLM may include further nested ELLM that is more specific within the general topic. For example, an ELLM 2200 for a finance department may be trained with finance data. Within the general finance related ELLM 2200, there may be nested ELLMs such as EMM 2210 for 10K/SEC filings, ELLM 2220 for forecast, and ELLM 2230 for revenue. If the nested ELLMs 2220 and 2230 are authorized to be used by employees that work in the finance department or only certain employees even within the finance department, such as managers in the finance department, then such nested ELLMs 2220 and 2230 may not be selected to respond to queries from other employees outside the finance department.

In some embodiments, the finance ELLM 2200 may contain nested ELLMs with varying access levels. ELLM 2210, trained on public 10K/SEC filings, may be accessible to all employees, nested ELLMs 2220 and 2230, incorporating sensitive data, may be restricted to finance department personnel. Upon receiving a user query, the system may identify the user and their department. If the user is not in the finance department, even if all nested ELLMs (2210-2230) could respond, only ELLM 2210 may be selected, ensuring data access aligns with user authorization.

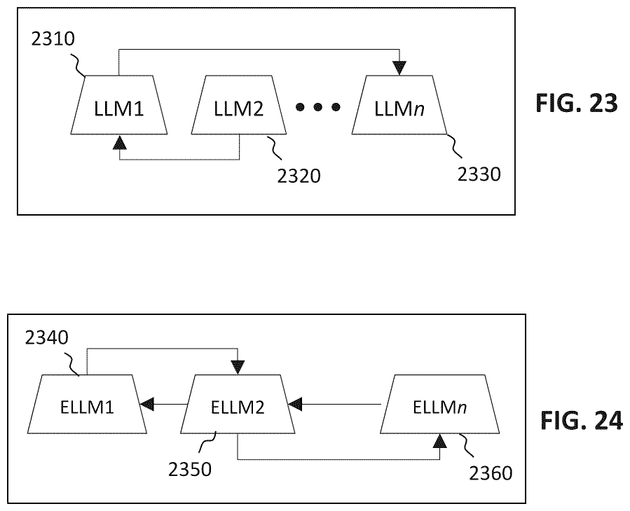

FIG. 23 is a block diagram of an example of using public LLMs to respond to the query, in accordance with some embodiments of the disclosure. As described above at least in FIGS. 7-9, 11-13, 16, and 18, the control circuitry 228 and/or 220 may select a plurality of LMMs to answer the query/question received. This may be at the initial stage of selecting a model or anytime through the response process when cascading/switching is performed to switch to another model due to an earlier model performing below a threshold confidence level. The LLMs selected and the order in which the LLMs are to be used may also be determined by the control circuitry 228 and/or 220. In some embodiments, the order of use may be predetermined and in other embodiments the order of use may be dynamically determined as results are obtained by LLMs that have processed the question. For example, after a first LLM, or a first set of LLMs have processed the question, the results from the processing may be used to determine which LLMs to select to continue processing the question. As depicted, in some embodiments, the control circuitry 228 and/or 220 may select LLM2 2320 to process the question received. Once the question has been processed by LLM2 2320, the control circuitry 228 and/or 220 may select LLM1 2310 to process the results obtained from LLM2. For example, LLM2 may provide a response which may be used as an input (such as in the form of a question or instructions) LLM1 to obtain a more refined response. Likewise, results from LLM1 may be used to further process them using LLMn 2330.

FIG. 24 is a block diagram of an example of using ELLMs to respond to a query, in accordance with some embodiments of the disclosure. As described above at least in FIGS. 7-9, 11-13, 16, and 18, the control circuitry 228 and/or 220 may select a plurality of LMMs to respond to the query/question received. This may be at the initial stage of selecting a model or anytime through the response process when cascading/switching is performed to switch to another model due to an earlier model performing below a threshold confidence level. ELLMs are enterprise LLMs that were trained using entries specific data, including confidential and proprietary enterprise data. The ELLMs selected and the order in which the ELLMs are to be used may be determined by the control circuitry 228 and/or 220. In some embodiments, the order of use may be predetermined and in other embodiments the order of use may be dynamically determined as results are obtained by ELLMs that have processed the question. For example, after a first ELLM, or a first set of ELLMs have processed the question, the results from the processing may be used to determine which nest ELLMs or set of ELLMs to select to continue processing the question. As depicted, in some embodiments, the control circuitry 228 and/or 220 may select ELLM2 2350 to process the question received. Once the question has been processed by ELLM2 2350, the control circuitry 228 and/or 220 may select ELLM1 2340 to process the results obtained from LLM2. The control circuitry 228 and/or 220 may select ELLM2 for a second time to process the results obtained from ELLM1 for a more enhanced answer. The control circuitry 228 and/or 220 may then process the enhanced answer received from ELLM 2 and then use ELLMn 2360 to obtain an even more refined response.

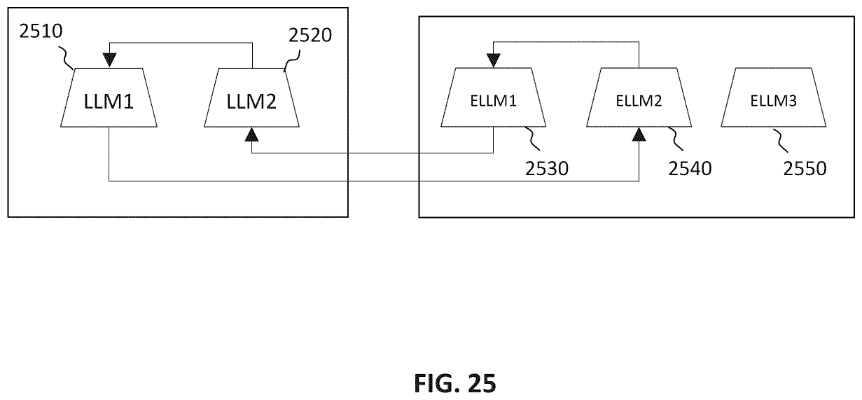

FIG. 25 is a block diagram of an example of using both public LLMs and ELLMs to respond to a query, in accordance with some embodiments of the disclosure.

As described above at least in FIGS. 7-9, 11-13, 16, and 18, the control circuitry 228 and/or 220 may select both public LLMs and ELLMs to respond to the query/question received. This may be at the initial stage of selecting a model or anytime through the response process when cascading/switching is performed to switch to another model due to an earlier model performing below a threshold confidence level. In addition to only using LLMs or ELLMs, there may be several combinations where both LLMs and ELLMs are used as part of a strategy to respond to a query/question inputted by the user. As depicted, in one instance, the strategy configured by the control circuitry 228 and/or 220 may be to use the LLMs and ELLMs in the following order: ELLM2 2540 à ELLM1 2530 à LLM2 2520 à LLM1 2510 à ELLM2 2540. Although ELLM3 may have been identified as a potential ELLM for us, the control circuitry 228 and/or 220 may determine not to use it as part of the strategy. The process of using one or more LLMs and ELLMs and using the results from one to process it again using a second LLMs and/or ELLMs or set second set of LLMs and ELLMs may result in the response continuously getting refined based on additional information gathered along the process and use of different types of training data used in each separate LLMs and ELLMs to respond to the query. Such iterative processes may be predetermined or may be dynamically determined as results from each LLMs and ELLMs are analyzed. Factors that may be used in determining the next set of LLMs and ELLMs may include, in some embodiments, type of response obtained, further explanation of concepts presented in the response, customizing the response to a specific audience, and clarifying or simplifying the response obtained from a previous LLMs and/or ELLMs used to process the query, or recommendations from a judge on the reasoning why a prior LLM or ELLM's performance exceeded or failed a threshold confidence level. Other factors such as using certain classes of data or quality of data may also be considered in determining which LLMs and/or ELLMs to select. Selection of LLM, ELLM, or combinations of both LLMs and ELLMs as depicted in FIGS. 23-24 may be based on any of the selection factors described herein, which include based on content, context, and category of query, identify of the user, and cost, accuracy or a combination thereof.

It should also be noted that although a reference may be made to using a single LLM or ELLM, a set of LLMs, ELLMs, and a combination thereof may also be used for selecting a model or cascading to a model. Likewise, unless specifically stated, an LLM, ELLM, and MLLM (multi-modal LLM) may be used interchangeably.

It will be apparent to those of ordinary skill in the art that methods involved in the above-mentioned embodiments may be embodied in a computer program product that includes a computer-usable and/or-readable medium. For example, such a computer-usable medium may consist of a read-only memory device, such as a CD-ROM disk or conventional ROM device, or a random-access memory, such as a hard drive device or a computer diskette, having a computer-readable program code stored thereon. It should also be understood that methods, techniques, and processes involved in the present disclosure may be executed using processing circuitry.

The processes discussed above are intended to be illustrative and not limiting. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

What is claimed is:

1. A method comprising:
receiving, in real-time, a query that is to be answered using one or more language models;
categorizing the query based on one or more categorization factors;
selecting an initial language model based on the categorization of the query;
generating a portion of a response to the query using the selected initial language model, wherein the portion of the response includes a first segment and a plurality of predictive second segments, one of which is to be selected as a second segment that sequentially follows the first segment;
determining a confidence score for the initial language model that reflects the initial language model's performance in predicting the plurality of predictive second segments;
determining whether the confidence score exceeds a confidence threshold; and
determining whether to switch from the initial language model to a second language model or continue with the initial language model for selecting the second segment based on the determined confidence score.

2. The method of claim 1, further comprising:
determining that the confidence score associated with the initial language model based on its performance in predicting the plurality of predictive second segments does not exceed the confidence threshold;
in response to determining that the confidence score does not exceed the confidence threshold, switching language models in midst of generating the response from the initial language model to a second language model.

3. The method of claim 2, further comprising
selecting a second segment, from a plurality of predictive second segments, generated by using the second language model, wherein the selection confirms the second segment as part of the response that follows the first segment.

4. The method of claim 2, further comprised:
generating a subsequent portion of the response using the second language model, wherein the subsequent portion of the response includes a third segment and a plurality of predictive fourth segments, one of which is to be selected as a fourth segment that sequentially follows the third segment;
determining a confidence score for the second language model that reflects the second language model's performance in predicting the plurality of predictive fourth segments;
determining whether the confidence score exceeds a confidence threshold; and
determining whether to switch from the second language model to a third language model or continue with the second language model for selecting the fourth segment based on the determined confidence score associated with the second language model's performance in predicting the plurality of predictive fourth segments.

5. The method of claim 1, further comprising:
repeating generating of subsequent portions of the response to the query until a complete response to the query has been generated; and
evaluating, at predetermined interim locations enroute to the complete response, whether a confidence score relating to a performance of an nth language model used for generating a plurality of predictive segments at the predetermined location exceed the confidence threshold; and
switching from the nth language model to a distinct language model if the confidence score relating to performance of an nth language model is below a threshold; or
continuing the generation of the subsequent portions of the response, one subsequent portion at a time, until the complete response to the query using the nth language model unless at any subsequent portion, the confidence score relating to performance of an nth language model for a segment of the subsequent portion drops below the threshold.

6. The method of claim 1, further comprising:
determining a level of granularity at which the confidence score of the initial language model is to be determined; and
determining the confidence score based on the determined level of granularity.

7. The method of claim 6, wherein the level of granularity is selected from any one of token, chunk, or response level.

8. The method of claim 6, further comprising:
determining locations during generation of the response based on the determined granularity; and
determining the confidence score based at the determined locations.

9. The method of claim 1, wherein the confidence score is determined using any one or more of the legit, self-reporting, reward, or judge-based techniques.

10. The method of claim 1, further comprising:
analyzing the received query;
determining based on the analysis that the query related to a complex category; and
in response to determining that the query related to a complex category, using a judge to determine a confidence score for the initial language model that reflects the initial language model's performance in predicting the plurality of predictive second segments.

11. The method of claim 1, wherein determining the confidence score further comprises:
using a first method and a second method to determine the confidence score;
detecting a score disparity between the first method and the second method; and
in response to detecting the score disparity between the first method and the second method:
determining whether an evaluation preference is towards the first method or the second method wherein the preference is based on a category of the query; and
using the preferred method, from the first or the second method, to calibrate a less preferred method, from the first and second method.

12. A system comprising:
communications circuitry configured to receive, in real-time, a query that is to be answered using one or more language models; and
control circuitry configured to:
categorize the query based on one or more categorization factors;
select an initial language model based on the categorization of the query;
generate a portion of a response to the query using the selected initial language model, wherein the portion of the response includes a first segment and a plurality of predictive second segments, one of which, is to be selected as a second segment that sequentially follows the first segment;
determine a confidence score for the initial language model that reflects the initial language model's performance in predicting the plurality of predictive second segments;
determine whether the confidence score exceeds a confidence threshold; and
determine whether to switch from the initial language model to a second language model or continue with the initial language model for selecting the second segment based on the determined confidence score.

13. The system of claim 12, further comprising:
determining that the confidence score associated with the initial language model based on its performance in predicting the plurality of predictive second segments does not exceed the confidence threshold;
in response to determining that the confidence score does not exceed the confidence threshold, switching language models in midst of generating the response from the initial language model to a second language model.

14. The system of claim 13, further comprising
selecting a second segment, from a plurality of predictive second segments, generated by using the second language model, wherein the selection confirms the second segment as part of the response that follows the first segment.

15. The system of claim 13, further comprised:
generating a subsequent portion of the response using the second language model, wherein the subsequent portion of the response includes a third segment and a plurality of predictive fourth segments, one of which is to be selected as a fourth segment that sequentially follows the third segment;
determining a confidence score for the second language model that reflects the second language model's performance in predicting the plurality of predictive fourth segments;
determining whether the confidence score exceeds a confidence threshold; and
determining whether to switch from the second language model to a third language model or continue with the second language model for selecting the fourth segment based on the determined confidence score associated with the second language model's performance in predicting the plurality of predictive fourth segments.

16. The system of claim 12, further comprising:
repeating generating of subsequent portions of the response to the query until a complete response to the query has been generated; and
evaluating, at predetermined interim locations enroute to the complete response, whether a confidence score relating to a performance of an nth language model used for generating a plurality of predictive segments at the predetermined location exceed the confidence threshold; and
switching from the nth language model to a distinct language model if the confidence score relating to performance of an nth language model is below a threshold; or
continuing the generation of the subsequent portions of the response, one subsequent portion at a time, until the complete response to the query using the nth language model unless at any subsequent portion, the confidence score relating to performance of an nth language model for a segment of the subsequent portion drops below the threshold.

17. The system of claim 12, further comprising:
determining a level of granularity at which the confidence score of the initial language model is to be determined; and
determining the confidence score based on the determined level of granularity.

18. The system of claim 17, wherein the level of granularity is selected from any one of token, chunk, or response level.

19. The system of claim 17, further comprising:
determining locations during generation of the response based on the determined granularity; and
determining the confidence score based at the determined locations.

20. The system of claim 12, further comprising:
analyzing the received query;
determining based on the analysis that the query related to a complex category; and
in response to determining that the query related to a complex category, using a judge to determine a confidence score for the initial language model that reflects the initial language model's performance in predicting the plurality of predictive second segments.
